(19) United States
(12) Patent Application Publication
(10) Pub. No.: US 2004/0190904 A1
(43) Pub. Date: Sep. 30, 2004

(54) Wavelength selection module comprising variable wavelength selecting section for selecting a plurality of wavelengths

(76) Inventors: Masaji Noguchi, Sashima (JP); Tomohiro Ueno, Oyama (JP); Hideyuki Miyata, Kawasaki (JP); Yutaka Kai, Kawasaki (JP)

Correspondence Address: Swidler Berlin Shereff Friedman, LLP, Suite 300, 3000 K Street, NW, Washington, DC, 20007-5116, US

(21) Appl. No.: 10/773,238

(22) Filed: Feb. 9, 2004

(30) Foreign Application Priority Data
Sep. 9, 2003 (JP) 2003-316973
Feb. 28, 2003 (JP) 2003-053336

(51) Int. Cl. H04J 14/02

(52) U.S. Cl. 398/85

(57) ABSTRACT

A selected wavelength variable optical filter for selecting and outputting the signal lights of the desired wavelengths from the light multiplexing light lights of a plurality of wavelengths. When the multiplexing factor of the WDM signal light increases, the number of selected wavelength variable optical filters used in the AOTF device or the like also increases, resulting in increase of manufacturing cost.

The number of filters used in the device can be lowered through introduction of a wavelength selection module which includes a wavelength selecting section for selecting and outputting a plurality of wavelengths from an input light using an external control signal, a demultiplexing means for demultiplexing an output light of the wavelength selecting section into a plurality of wavelengths, and a filter means for filtering an output light of the demultiplexing means for every wavelength bandwidth.

### BACKGROUND OF THE INVENTION

1. Field of the Invention

The present invention relates to a wavelength. selection module for selecting and outputting the light of the particular wavelength from the wavelength- multiplexed light, and a wavelength selection module provided with an optical add/drop multiplexing device using the same module, particularly a variable wavelength selecting section utilizing an acousto-optic effect.

2. Description of the Related Art

In the field of communication systems, demand for an optical communication system that enables long distance and large capacity transmission is increasing in order to establish a network with large capacity and flexibility. As a system to realize long distance and large capacity transmission, wavelength-division multiplexing (WDM) communication has been widely introduced. A WDM communication system utilizes the wide frequency band and large capacity characteristics of optical fiber. Investigation and development of networks employing WDM communication is ongoing.

In order to construct a network of flexible structure using the optical communication system, the function for passing, branching and inserting light signals, light routing function to select transmission destination of each light signal, and cross-connecting function are required at each point on the network. As means for realizing the function of passing, branching and inserting the light signal, an optical add/drop multiplexing (OADM) device is now under research and development. As the OADM device, the wavelength fixing type OADM device which can add and drop the light signal of fixed wavelength and the desired wavelength type OADM device which can add and drop the light signal of desired wavelength have been proposed.

Meanwhile, an acousto-optic tunable filter (AOTF) is used to select the wavelength by utilizing the acousto-optic effect and is capable of selecting the light of the wavelength corresponding to a radio frequency(RF) signal impressed from an external circuit. Unlike the Fiber Bragg Grating (FBG) in which the selected wavelength is fixed, the desired wavelengths can be selected by changing the frequency of the RF signal. Moreover, such an AOTF is characterized in that the range of selected wavelength is wide (80 nm or wider), tuning speed is high (10 msec or less) and a plurality of wavelengths can be selected simultaneously. Moreover, since the AOTF is also a wavelength tunable optical filter, it can also be used as a wavelength tunable optical filter in a tributary for adding and dropping light signal between the terminal stations. With the reasons described above, the OADM device utilizing the AOTF is now under research and development.

The AOTF is an optical element utilizing the acousto-optic effect, as illustrated in FIG. 18, and is capable of selecting the wavelengths by utilizing mode conversion based on the interaction of surface acoustic wave (SAW) and light. Referring to FIG. 18, the AOTF is comprised of optical waveguides 24A to 24B, polarized beam splitters (PBSs) 23A to 23B, a: SAW waveguide 22A, an inter digit transducer (IDT) 21A, and absorbers 25A to 25B which are formed on a substrate 26A having birefringence and acousto-optic effects.

As the substrate 26A, LiNbO₃ having the birefringence and acousto-optic effects is used and the optical waveguides 24A to 24B and PBSs 23A to 23B are formed thereon by diffusing Ti or the like. The optical waveguides 24A and 24B are crossing at the two positions and the waveguide type PBSs 23A to 23B are provided at the crossing positions. The PBSs 23A and 23B are polarization and isolation elements for changing the running direction of the light based on the polarization of light in the incident optical waveguide.

The SAW waveguide 22A is used for propagation of a SAW generated by the IDT 21A and the SAW and light results in the interaction thereof at the region where the optical waveguides 24A and 24B cross. The IDT 21A includes an electrode for generating a SAW based on the RF signal supplied from an RF signal generating section 2A of an external circuit. In the region where the SAW waveguide and the optical waveguide cross, the refraction index of the optical waveguides 24A and 24B changes periodically in accordance with the wavelength of the SAW.

Accordingly, the polarizing surface rotates within the light having the particular wavelength showing interaction in combination with periodical change of the refraction index of the optical waveguide due to the SAW among the lights propagated by the optical waveguides 24A and 24B. Thereby, the TE light is changed to the TM light, while the TM light is changed to the TE light through the replacement of operation modes. The amount of rotation of the polarizing surface of the light due to the interaction with the SAW changes in proportion to working length of the interaction and intensity of the RF signal impressed to the IDT for generation of the SAW. Therefore, the wavelength of the light to be converted in the operation mode with the SAW can be controlled by selecting the working length of the interaction and intensity of the RF signal.

In the structure where the optical waveguide and the SAW waveguide cross, as illustrated in FIG. 18, the SAW waveguide can be formed with formation of a metal film. With the AOTF, in the case of selecting the light of the C-band (sometimes called the 1550 nm band, and spanning from about 1530 nm to about 1560 nm) and the L-band (sometimes called the 1580 nm band, and spanning from about 1570 nm to about 1610 nm) which are used for the optical communication, the corresponding RF signal frequency to be applied ranges from 170 MHz to 180 MHz. In addition, the absorbers 25A to 25B are also provided to prevent propagation of the SAW with the waveguide other than the SAW waveguide 22A.

Here, it is assumed that the lights in the wavelengths λ₁, λ₂, λ₃ are inputted to the AOTF as illustrated in FIG. 18, while only the light in the wavelength λ₁ is selected with the external RF signal and is then outputted. The lights in the wavelengths λ₁, λ₂, and λ₃ incident to the input (IN) port are split to the TE lights and TM lights with the PBS 23A. The TM lights in the wavelengths λ₁, λ₂, and λ₃ are propagated through the optical waveguide 24B, while the TE lights in the wavelengths λ₁, λ₂, and λ₃ are propagated through the optical waveguide 24A. The frequency and intensity of the RF signal are selected to realize mode conversion of the light in the wavelength λ₁ with the interaction of the SAW and light. Since the mode conversion is realized for the light in the wavelength λ₁ when the RF signal is applied to the IDT 21A with the RF signal generating section 2A, the TM light in the wavelength λ₁ and the TE light in the wavelengths λ₂, λ₃ are incident to the PBS 23B from the optical waveguide 24A, while the TM light in the wavelengths λ₂, λ₃ and the TE light in the wavelength λ₁ are incident to the PBS 23B from the optical waveguide 24B.

The TE lights in the wavelengths λ₂, λ₃ among the lights inputted from the optical waveguide 24A with the PBS 23B are outputted to a transmitting (THRU) port, while the TM light in the wavelength λ₁ to a dropping (DROP) port. Moreover, the TE lights in the wavelengths λ₂, λ₃ among the lights inputted from the optical waveguide 24B are outputted to the transmitting (THRU) port, while the TE. light in the wavelength λ₁ to the dropping (DROP) port. Accordingly, since the TE lights and TM lights in the wavelengths λ₂, λ₃ are outputted to the transmitting (THRU) port, while the TE light and TM light in the wavelength λ₁ to the dropping (DROP) port, the lights in the wavelengths selected by the RF signal generating section is outputted to the dropping (DROP) port, while the lights of the other wavelengths to the transmitting (THRU) port without relation to the polarization of the TE or TM light.

As described above, the AOTF is capable of selecting and dropping only the light in the wavelength corresponding to the frequency of RF signal and moreover changing the selected wavelength by changing the frequency of this RF signal. In addition, since the light outputted from the transmitting (THRU) port is identical to the light (in the wavelengths λ₂, λ₃) which is obtained by removing only the light in the wavelength (λ₁) corresponding to the frequency of RF signal from the lights (in the wavelengths λ₁, λ₂, λ₃) inputted from the inputting (IN) port, this AOTF may also be used as a filter having the rejection function for disabling output of the light in the particular wavelength.

Moreover, when the lights in the wavelengths λ₄, λ₅, and λ₆ are inputted to the adding (ADD) port, while the RF signal corresponding to the wavelength 14 is impressed to the IDT 21A, the light in the wavelength λ₄ is outputted to the transmitting (THRU) port, while the lights in the wavelengths λ₅, λ₆ to the dropping (DROP) port. Accordingly, when the light is inputted to the adding (ADD) port of the AOTF, light in the wavelengths corresponding to the frequency of RF signal applied to the IDT 21A is outputted to the transmitting (THRU) port, while light of the other wavelengths is outputted to the dropping (DROP) port.

The AOTF has a temperature characteristic such that the selected wavelength deviates by 100 GHz (about 0.8 nm in terms of wavelength conversion) for each temperature change of 1° C.

Meanwhile, wavelength intervals of the WDM light signal is specified, for example, as 0.8 nm according to the ITU-TG. 692 Recommendation. When temperature of the AOTF has changed, another light signal that is different from the light signal of the target wavelength is selected, if the frequency of the RF signal to be applied to the AOTF is left unchanged. The temperature control method for the AOTF in order to use the AOTF in the WDM communication is also under the research and development. (For example, see Japanese Published Unexamined Patent Application No. 2000-241782)

FIG. 19 illustrates an OADM device based on the prior art utilizing a wavelength selection module utilizing the AOTF. The OADM device of FIG. 19 includes optical couplers 9A to 9C, an optical amplifier 11A, an optical amplifier 11B, variable wavelength selection modules 20A to 20D, a transponder section 15A, an optical attenuator (ATT) section 12A, and a band rejection filter (BRF) 16A. Moreover, the transponder section 15A is comprised of an optical receiving section 13A and an optical transmitting section 14A.

The variable wavelength selection modules 20A to 20D are wavelength selection modules utilizing the AOTF and selects the light of the particular wavelength from the input light and then outputs the selected light. Moreover, the BRF 16A utilizes the rejection function of the AOTF and outputs, to the transmitting (THRU) port, the light corresponding to the frequency of the RF signal inputted among the lights inputted from the adding (ADD) port. Moreover, the BRF 16A outputs, to the dropping (DROP) port, the light corresponding to the frequency of the RF signal inputted among the lights inputted from the inputting (IN) port but does not output this light to the transmitting (THRU) port.

The transponder section 15A receives the input signal light with the optical receiving section 13A, adds the input signal light, after conversion to an electrical signal, to the WDM signal light with the optical transmitting section 14A, and transmits the signal as the light signal of the wavelength which can be multiplexed.

In the OADM device illustrated in FIG. 19, the lights in the wavelengths of λ₁ to λ₄ are dropped from the input WDM signal light as the light of the single wavelength. This single wavelength light is then outputted and the added light is then multiplexed to the WDM signal lights and also outputted as the lights in the wavelengths of λ₅ to λ₈.

The WDM signal light inputted to the inputting (IN) port of the OADM device is demultiplexed with the coupler 9A and is then inputted to the BRF 16A and the optical amplifier 11A. The light inputted to the optical amplifier 11A is amplified, and demultiplexed with the coupler 9B and then inputted to the variable wavelength selection modules 20A to 20D. The variable wavelength selection modules 20A to 20D select, respectively, the lights in the wavelengths of λ₁, λ₂, λ₃, and λ₄ and then outputs these lights to the dropping optical port of the OADM device as the light of a single wavelength.

Meanwhile, the signal light inputted to the adding port of the OADM device is changed in the wavelength with the transponder section 15A and is then outputted as the lights in the wavelengths of λ₅, λ₆, λ₇, λ₈. The lights outputted in the wavelengths of λ₅ to λ₈ are amplified with the optical amplifier 11B, adjusted in intensity with the ATT section 12A, multiplexed with the coupler 9C, and are then inputted to the adding (ADD) port of the BRF 16A.

The WDM signal light demultiplexed with the coupler 9A is inputted to the inputting (IN) port of the BRF 16A and light in the wavelengths λ₅ to λ₈ multiplexed with the coupler 9C are inputted to the adding (ADD) port of the BRF 16A. The RF signals of the frequency corresponding to the wavelengths λ₅ to λ₈ are inputted to the BRF 16A in order to output the light inputted to the adding (ADD) port to the transmitting (THRU) port. Accordingly, light in the wavelengths of λ₅ to λ₈ among the WDM signal lights inputted to the inputting (IN) port are outputted to the dropping (DROP) port and thereby light, except for the light in the wavelengths of λ₅ to λ₈, are then outputted to the transmitting (THRU) port.

Accordingly, the wavelength-multiplexed signal of the light except for light in the wavelengths of λ₅ to λ₈, and light in the wavelengths of λ₅ to λ₈ inputted to the adding (ADD) port of the BRF 16A among the WAD signal lights inputted to the OADM device is outputted.

In the network of known optical transmission systems, communication by the stream system for continuously transmitting the signal light between the transmitting terminal and the receiving terminal is performed. Moreover, in these known optical transmission systems, the technology for repeating the data with an optical signal without conversion to an electrical signal is gradually being utilized in practical ways. In systems for relaying all data with an optical signal, transmission costs can be reduced, for instance, by avoiding requirements for opto-electric (O/E) and/or electro-optic (E/O) converters. Moreover, in systems for repeating all data with the optical signal, a repeater independent from bit rate and protocol can be realized by switching the signal light itself. In addition, in order to realize a flexible network configuration, there is currently under investigation a repeating node that can switch the transmission route for each signal light wavelength.

On the other hand, there is under investigation an optical burst switching system in which signal transmission is not performed, unlike the current stream system, after establishment of communication between the terminals, but instead, the repeating node is switched for each separated data. FIG. 20(a) schematically illustrates an optical network structure for communications based on an optical burst switching system, while FIG. 20(b) schematically illustrates changes with time of the signals transmitted to the control channel and data channel in the optical burst switching system.

In FIG. 20(a), the optical burst switching network 70 for making communication with the optical burst switching system includes an edge node 73 for transmitting burst data by connecting the optical burst switching network 70 and an access network 71 and a repeating node for switching the transmission route of burst data depending on the information of control packets transmitted by the control channel. The N data channels consisting of the WDM signal lights are used for connection between the edge node and the repeating node or between the repeating nodes.

FIG. 20(b) illustrates the time relationship between the control packet and burst data in the communication based on the optical burst switching system. In the communication based on the optical burst switching system, the control packet is transmitted to the control channel prior to the data with the edge node 73. The control packet is converted to an electrical signal and is then processed with the repeating node 74 and the data channel is switched in the repeating node 74 based on the contents of the control packet. After transmission of the control packet, the burst data is transmitted in the offset time T1 and the repeating node which has been switched based on the contents of control packet is transmitted as the optical signal and is then transmitted to the target edge node.

Since the data channels of the particular wavelengths are assigned to the burst data transmitted with the optical burst switching system only within the time required for transmission of burst data, application efficiency of the optical network can be improved.

The switching time T2 of data channel in the optical burst switching system has the order of msec or less, and the switching time in the order of msec or less is required as the switching time of the repeating node illustrated in FIG. 20(a).

### SUMMARY OF THE INVENTION

When a variable wavelength selection device using an AOTF is used for the stream communication, the RF signal is adjusted to select the desired wavelength before the beginning of communication. After the communication has been started, it is possible to make ready for change of the relationship between the RF signal frequency and selected wavelength due to temperature change or the like by conducting the adjustment (tracking) following the signal light of the inputted target wavelength. Therefore, it is enough when only the adjustment of the relationship between the desired selected wavelength and RF signal frequency is considered before the beginning of communication.

Meanwhile, since the data channel of a certain wavelength is assigned in the optical burst switching system only in the time required for transmission of burst data, restoration of the relationship between the RF signal frequency and selected wavelength by the tracking is insufficient and, therefore, the relationship between the RF signal frequency and selected wavelength has to be recognized correctly whenever the wavelength is switched.

Moreover, a single wavelength branching light can be obtained, in the OADM device using a variable wavelength selection device such as an AOTF, by changing the selected wavelength of light of the variable wavelength selection device. However, the number of wavelengths to be multiplexed increases in the WDM communication. When the number of signals to be dropped and added increases at each point of the network, it is required to provide the variable wavelength selection device such as the AOTF as many as the number of signals to be dropped and added.

Therefore, it is required to provide the variable wavelength selection devices as many as the number of signals to be added and dropped in order to increase the number of signal lights to be added and dropped in the AOTF device. This causes the manufacturing cost to increase.

The present invention has been proposed to solve the problems noted above by providing a wavelength selection module which includes a wavelength selecting section for inputting the light obtained by multiplexing a plurality of signal lights of different wavelengths and selecting and outputting the signal lights of a plurality of wavelengths depending on a control signal applied from an external circuit, and a demultiplexing means for demultiplexing and outputting an output light of the wavelength selecting section in every wavelength.

In another aspect of the invention, the wavelength selection module includes means for inputting an output light of the demultiplexing means and outputting the light of the unwanted wavelength through attenuation thereof.

Preferably, the wavelength selection module of the present invention includes a wavelength selecting section for inputting a plurality of lights in different wavelengths and selecting and outputting the lights of a plurality of wavelengths depending on the control signal applied from an external circuit, a branching means for branching an output of the wavelength selecting section to the first and second lights, a first filter for inputting the second light and selectively transmitting the light of the particular wavelength, and a control section for adjusting the relationship between the control signal and selected wavelength applied to the wavelength selecting section based on the control signal, output of the first filter and transmitting wavelength of the filter.

In another aspect of the invention, the wavelength selection module includes a reference light source which provides constant output wavelength, a multiplexing means for multiplexing an input light including the lights of a plurality of wavelengths and an output light of the reference light source, a wavelength selecting section for inputting an output light of the multiplexing means and selecting and outputting the lights of a plurality of wavelengths depending on the control signal applied from an external circuit, a branching means for branching an output of the wavelength selecting section into the first and second lights, a first filter for inputting the second light and selectively transmitting the light of the output light wavelength of the reference light source, and a control section for adjusting the relationship between the control signal and selected wavelength given to the wavelength selecting section based on the control signal, output of the first filter and wavelength of the reference light source.

Preferably, the wavelength selection module of the present invention includes first and second reference light sources for providing a constant output wavelength, a multiplexing means for multiplexing an input light including a plurality of lights of different wavelengths and an output lights of the first and second reference light sources, a wavelength selecting section for inputting an output light of the multiplexing means and selecting and outputting the lights of a plurality of wavelengths depending on the control signal applied from an external circuit, a branching means for branching an output of the wavelength selecting section to the first to third lights, a first filter for inputting the second light and selectively transmitting the light of output light wavelength of the first reference light source, a second filter for inputting the third light and selectively outputting the light of output light wavelength of the second reference light source, and a control section for adjusting a relationship between the control signal and selected wavelength applied to the wavelength selecting section based on the relationship among the control signal, output of the first filter and wavelength of the first reference light source and the relationship among the control signal, output of the second filter and wavelength of the second reference light source.

In another aspect of the invention, the wavelength selection module is the wavelength selection module described above, and includes means for controlling the control signal to continuously select, with the wavelength control section, the light selectively transmitted by the first or second filter.

A wavelength selection module of the present invention may include means for controlling the output to the first light of the wavelength of the light selectively transmitted by the first or second filter by controlling output of the control signal corresponding to the light selectively transmitted by the first or second filter.

In a further aspect of the invention, the wavelength selection module includes a control section which includes a third filter for inputting the first light and attenuating the wavelength of light selectively transmitted by the first or second filter.

Moreover, the number of wavelengths of the signal lights which can be added and dropped simultaneously can be increased, without remarkable increase of the number of wavelength selecting sections used, by applying the variable wavelength selection modules of the present invention to an optical add/drop multiplexing device.

According to the wavelength selection module of the present invention, a wavelength selection module is provided for selectively outputting the lights of two or more different wavelengths through the demultiplexing process from the multiplexed lights of a plurality of different wavelengths

Moreover, the number of signal light wavelengths which can be added and dropped simultaneously can be increased, without remarkable increase of the number of wavelength selecting sections to be used by adapting the wavelength selection module of the present invention to the optical add/drop demultiplexing device.

In addition, according to the wavelength selection module of the present invention, the relationship between the control signal and selected wavelength can be adjusted during selection of the light of a particular wavelength. Therefore, the signal light of the target wavelength can be selected even in the case where the time for adjusting relationship between the control signal and selected wavelength cannot be provided individually because the selected wavelength in the operating profile of the optical burst switching system is switched frequently.

The many features, objects and advantages of the present invention will be apparent from the following description of the preferred embodiments, considered along with the accompanying drawings.

### BRIEF DESCRIPTION OF THE DRAWINGS

FIG. 1 is a schematic diagram illustrating a wavelength selection module of the present invention;

FIGS. 2(a) to 2(d) are schematic diagrams illustrating light intensity at the respective points in the wavelength selection module of the present invention;

FIGS. 3(a) to 3(d) are schematic diagrams illustrating relationships between selected wavelength and input light of the wavelength selecting section used in the wavelength selection module of the present invention;

FIG. 4 is a schematic diagram illustrating the spectra of the reference light and signal light;

FIG. 5 is a schematic diagram illustrating the wavelength selection module of the present invention;

FIG. 6 is a schematic diagram illustrating the wavelength selection module of the present invention;

FIG. 7 is a schematic diagram illustrating the wavelength selection module of the present invention;

FIG. 8 is a schematic diagram illustrating the wavelength selection module of the present invention;

FIG. 9 is a schematic diagram illustrating the wavelength selection module of the present invention;

FIG. 10 is a schematic diagram illustrating the relationship between RF signal intensity applied to an acousto-optic tunable filter (AOTF) and an output light intensity;

FIG. 11 is a schematic diagram illustrating an optical add/drop multiplexing device of the present invention;

FIG. 12 is a schematic diagram illustrating the optical add/drop multiplexing device of the present invention;

FIGS. 13(a) and 13(b) are schematic diagrams illustrating structures of an RF signal generating section;

FIG. 14 is a schematic diagram illustrating a structure of a direct digital synthesizer;(DDS).

FIG. 15 is a schematic diagram illustrating a structure of the DDS;

FIGS. 16(a) and 16(b) are schematic diagrams illustrating structures of a monitoring section and a control section;

FIG. 17 is a schematic diagram illustrating a structure of a reference light generating section;

FIG. 18 is a schematic diagram illustrating an AOTF structure;

FIG. 19 is a schematic diagram illustrating a known optical add/drop multiplexing device; and

FIGS. 20(a) and 20(b) are schematic diagrams illustrating, respectively, an optical burst switching system and a time relationship between a control packet and a burst data in the communication based on an optical burst switching system.

### DETAILED DESCRIPTION OF THE PREFERRED EMBODIMENTS

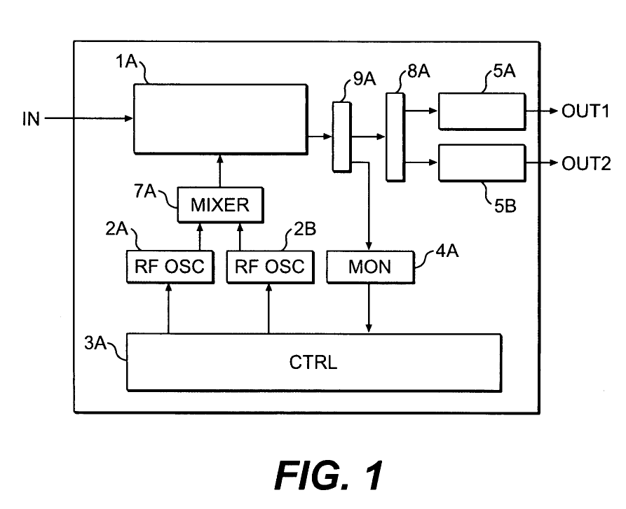

A wavelength selection module according to a first embodiment of the present invention is shown in FIG. 1. The module includes a wavelength selecting section 1A, a control section (CTRL) 3A, RF signal oscillating sections (RF OSC) 2A to 2B, a mixing section (Mixer) 7A, a monitoring section (MON) 4A, a coupler 9A, a wavelength isolating filter 8A as a demultiplexing means, and optical filters 5A to 5B.

The wavelength selecting section 1A is a wavelength selecting element which can select and output, from the input light where the lights of a plurality of wavelengths are multiplexed, the lights of a plurality of wavelengths with a control signal supplied from an external circuit. Any suitable device, such as an acousto-optical tunable filter (AOTF), can be used as this element.

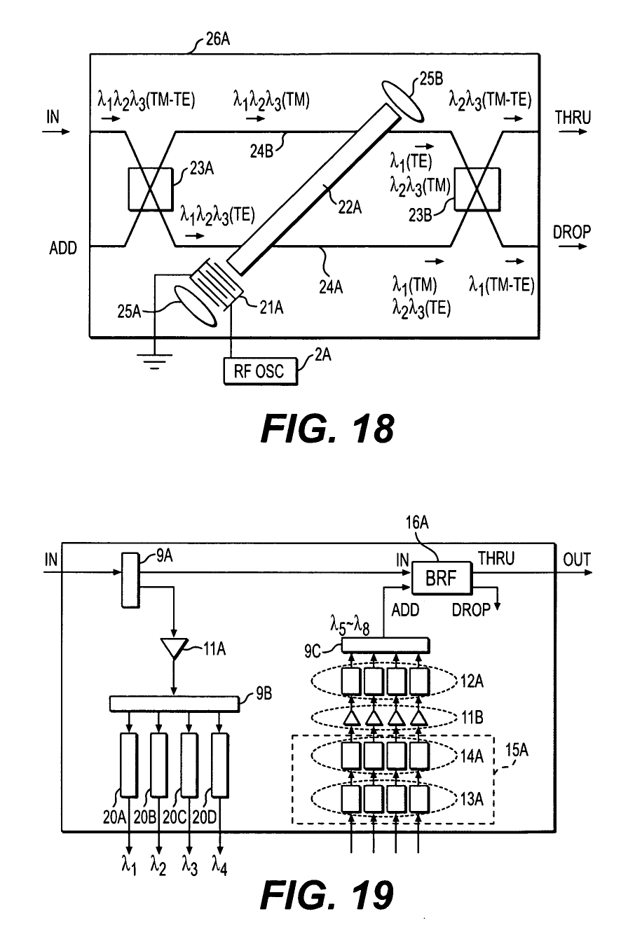

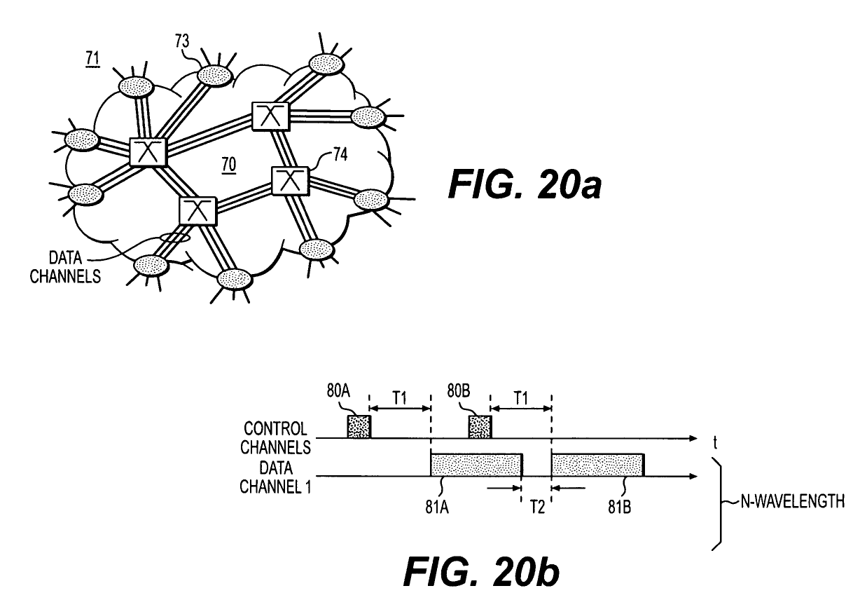

The AOTF selects the light of the wavelength corresponding to the frequency of the RF signal applied to an inter digit transducer (IDT) (such as IDT 21A of FIG. 18) through the RF signal input port among the lights inputted to the inputting (IN) port and then outputs the selected light from a dropping(DROP) port. When the RF signals of a plurality of frequencies are inputted to the RF signal input port, the lights of the wavelengths corresponding to the respective RF signal frequencies are selected and outputted.

The RF signal oscillating sections 2A and 2B generate the RF signal corresponding to the target selected wavelength under the control of the control section 3A. FIGS. 13(a) and 13(b) illustrate an example of the structure of the RF oscillating section and output the RF signal of the target frequency by amplifying, filtering and outputting the RF signal generated by the direct digital synthesizer (DDS).

The coupler 9A demultiplexes a part of the lights outputted from the wavelength selecting section 1A to the monitoring section 4A and outputs the remaining light to a wavelength isolating filter 8A.

The wavelength isolating filter 8A is a filter for isolating an output from the coupler 9A to an optical filter 5A and optical filter 5B. The wavelength isolating filter 8A according to the first embodiment demultiplexes and outputs, to the optical filter 5A, the light in the wavelength range of the C-band among the lights outputted from the coupler 9A and also demultiplexes and outputs, to the optical filter 5B, the light in the wavelength region of the L-band.

As the wavelength isolating filter 8A, a low-pass filter or a high-pass filter which can isolate the wavelengths in the wider band and the wavelength band can be divided into two bands to provide individual outputs by utilizing the transmitting wavelength and reflection wavelength of the low-pass filter or high-pass filter. The structure of the filter for dividing the wavelength band into two bands is more simplified than that of the filter for extracting the particular wavelength and thus can be provided at lower cost.

The optical filter 5A is an optical filter for transmitting only the light in the C-band region and attenuates the light other than that in the C-band region of the lights demultiplexed by the wavelength isolating filter 8A. Therefore, only C-band light selected by the wavelength selecting section 1A is outputted to the outputting (OUT) port 1 of the optical filter.

Similarly, the optical filter 5B is an optical filter for transmitting only light in the C-band region and attenuates the light other than that in the L-band region demultiplexed by the wavelength isolating filter 8A. Therefore, only L-band light selected by the wavelength selecting section 1A is outputted to the outputting (OUT) port 2 of the optical filter.

Since the optical filters 5A and 5B are filters for complementing the demultiplexing operation of the wavelength isolating filter 8A, a low cost filter such as a low-pass filter and a high-pass filter which assure wider transmitting bandwidth may be used.

Namely, the lights in a plurality of wavelengths selected by the wavelength selecting section 1A can be outputted from the outputting (OUT) ports 1 and 2, as in the case where a single wavelength is selected, by combining the low cost wavelength isolating filter 8A and the low price optical filters 5A and 5B.

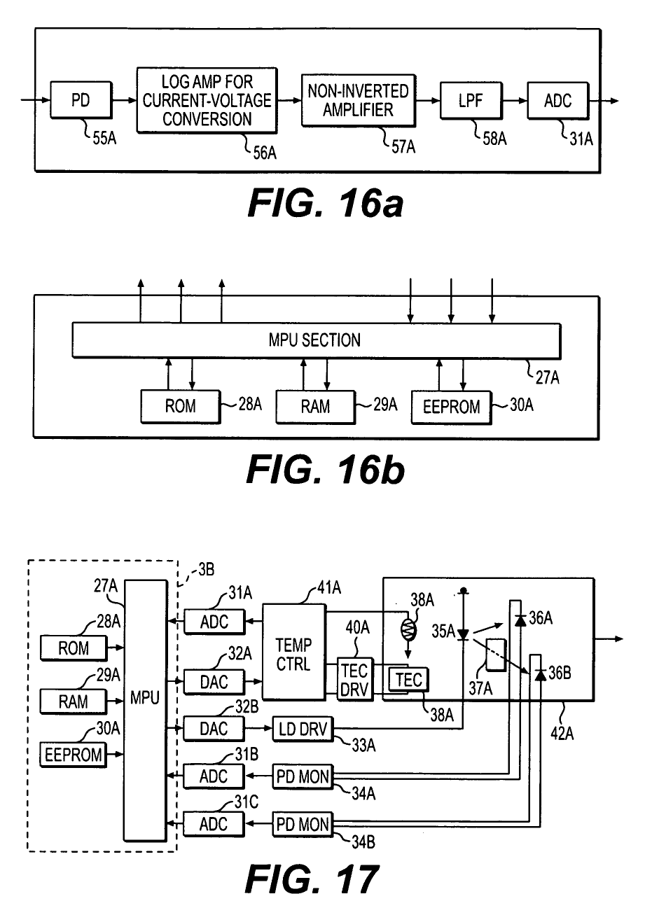

The monitoring section 4A inputs the light demultiplexed by the coupler 9A and outputs its intensity as a digital signal to the control section 3A. FIG. 16(a) illustrates an example of the monitoring section 4A. This monitoring section receives the input light with a photodiode (PD) 55A, converts the input light to an electrical signal and thereafter amplifies the signal in the logarithmic (Log) level with a Logarithmic (Log) amplifier 56A for current-voltage conversion. An output of the Log amplifier 56A for current-voltage conversion is amplified with a non-inverted amplifier 57A, filtered with a low-pass filter (LPF) 58A, and thereafter converted to a digital signal as the output signal with an analog-digital converter (ADC) 31A. The monitoring section 4A is capable of outputting the light in the intensity of the wider dynamic range as the digital signal by utilizing the Log amplifier 56A for current—voltage conversion. Accordingly, this monitoring section 4A can provide a digital signal as the output related to the intensity of input light without relation to the intensity of the input light demultiplexed with the wavelength isolating filter 8A.

The control section 3A inputs the digital signal outputted from the monitoring section and outputs control signals for specifying frequency, amplitude and phase of the signals generated by the RF oscillating sections 2A and 2B. The control section 3A is comprised, as illustrated in FIG. 16(b), of an MPU section 27A, a ROM section 28A, a RAM section 29A and an EEPROM section 30A. The ROM section 27A is used as a storing means for storing the program for operating the control section or the like, the RAM section 29A as a temporary data storing means, and the EEPROM section 30A as a means for storing the setting information.

### The RF Signal Oscillating Section

FIG. 13(a) illustrates a structure of the RF signal oscillating section for generating the RF signal corresponding to the selected wavelength with a multiplier which is described in the specification of the Japanese Published Unexamined Patent Application No. 2000-149555. The RF signal oscillating section illustrated in FIG. 13(a) is comprised of a direct digital synthesizer (DDS) 51A, band-pass filters (BPF) 52A to 52C, radio frequency amplifiers (RF AMP) 53A to 53C and a multiplier 54A.

The direct digital synthesizer (DDS) 51A outputs the RF signals which are deviated, with the control signal supplied from an external circuit, in the phase by p/2 of the designated frequency (85 MHz to 90 MHz) (hereinafter, these signals are called a sine-wave signal and a cosine-wave signal). The sine-wave signal and the cosine-wave signal outputted from the DSS 51A are respectively subjected to elimination of unwanted frequency elements with a band-pass filter 52A or 52B and then amplified with a high frequency amplifier 53A or 53B and inputted to a multiplier 54A.

Since the sine-wave signal and the cosine-wave signal are isolated in the phase by π/2, these signals are multiplied by the multiplier 54A and are then outputted in the signal of the doubled frequency (170 MHz to 180 MHz). The RF signal outputted from the multiplier 54A is subjected to elimination of the unwanted frequency element by the band-pass filter 52C, amplified with the high frequency amplifier 53C and outputted as an output of the RF signal oscillating section.

The RF signal oscillating section illustrated in FIG. 13(a) outputs the frequency (170 MHz to 180 MHz) corresponding to the selected wavelength of the wavelength selecting section by using the multiplier even when the frequency of RF signal which is outputted in direct from the DDS is lower than the frequency (170 MHz to 180 MHz) corresponding to the selected wavelength of the wavelength selecting section.

### The DDS

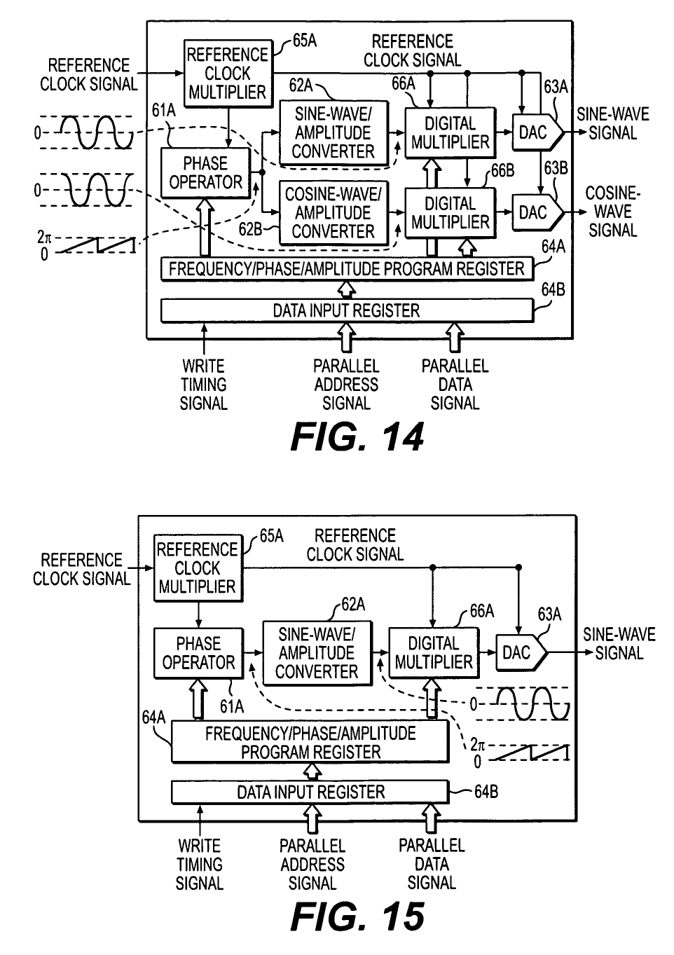

FIG. 14 illustrates an example of the DDS 51A used in FIG. 13(a). The DDS illustrated in FIG. 14 includes a reference clock multiplier 65A, a phase operator 61A, a sine-wave/amplitude converter 62A, a cosine-wave/amplitude converter 62B, digital multipliers 66A to 66B, D/A converters (DAC) 63A to 63B, a frequency/phase/amplitude program register 64A, and a data input register 64B.

In FIG. 14, a frequency/phase/amplitude setting information from an external control device is inputted to the data input register 64B as a write timing signal, parallel address signal and parallel data signal. The respective signals inputted are then inputted to the frequency/phase/amplitude program register 64A from the data input register 64B, the phase setting information about frequency is inputted to the phase operator 61A and the amplitude setting information is inputted to the digital multipliers 66A and 66B.

Moreover, the reference clock multiplier 65A generates the reference clock signal based on the reference clock signal from an external circuit of the DDS 51A and then applies this reference clock signal to the phase operator 61A, digital multipliers 66A to 66B, D/A converters 63A to 63B. The phase operator 61A inputs the phase information of 0 to 2π to the sine- wave/amplitude converter 62A and the cosine-wave/amplitude converter 62B in every reference time based on the reference clock signal. The sine-wave/amplitude converter 62A converts the signal to the amplitude data with reference to a sine-wave look-up table stored therein, while the cosine-wave/amplitude converter 62B converts the signal to the amplitude data with reference to a cosine-wave look-up table stored therein. Accordingly, the digital signal of the sine-wave amplitude information is outputted from the sine-wave/amplitude converter 62A and the digital signal of the cosine-wave amplitude information is also outputted from the cosine-wave/amplitude converter 62B, depending on the phase information of 0 to 2π outputted from the phase operator.

The digital multiplier 66A multiplies the digital signal of the sine-wave amplitude information inputted from the sine-wave/amplitude converter 62A and the amplitude value based on the amplitude setting information inputted from the frequency/phase/ amplitude program register 64A and provides an output to the D/A converter 63A. Similarly, the digital multiplier 66B multiplies the digital signal of the cosine-wave amplitude information inputted from the cosine-wave/amplitude converter 62B and the amplitude value based on the amplitude setting information inputted from the frequency/phase/amplitude program register 64A and provides an output to the D/A converter 63B.

The D/A converters 63A and 63B respectively convert the digital signals outputted from the digital multipliers 66A and 66B and provide the outputs of sine-wave signal and cosine-wave signal.

In the DDS illustrated in FIG. 14, since the amplitudes of the sine-wave signal and cosine-wave signal to be outputted are determined based on the amplitude information of the sine-wave and cosine-wave digital signals and the amplitude setting information of the frequency/phase/amplitude program register, the signal output can be controlled to the predetermined amplitude value without provision of a variable attenuator.

Moreover, when it is required to vary the output frequency of DDS, since the output signal frequency is changed by changing the phase setting information about the frequency to be applied to the phase operator 61A with the parallel data signal, the output signal frequency can be changed more quickly than the frequency change when a PLL circuit is used. Accordingly, when the DDS is used as the RF signal source of the wavelength selecting section, the time required for switching the selected frequency of the wavelength selecting section can be set, for example, to about 1 ms, which is about 1000 times shorter than the time required when the PLL is used as the RF signal source of the wavelength selecting section.

### The RF Signal Oscillating Section

FIG. 13(b) illustrates another structure of the RF signal oscillating section to generate the RF signal corresponding to the selected wavelength with the multiplier. The RF signal oscillating section illustrated in FIG. 13(b) is comprised of a DDS 51B, a band-pass filter (BPF) 52D and a high frequency amplitude (RF AMP) 53D.

The DDS 51B outputs the frequency (170 MHz to 180 MHz) designated with the external control signal. The RF signal outputted from the DDS 51B is subjected to elimination of unwanted frequency element by the band-pass filter 52D, amplified with the high frequency amplifier 53D, and outputted as the output of RF signal oscillating section.

Since the DDS is capable of outputting directly the frequency (170 MHz to 180 MHz) corresponding to the selected wavelength of the wavelength selecting section in the RF signal oscillating section illustrated in FIG. 13(b), the structure can be more simplified than that of the structure illustrated in FIG. 13(a) where the frequency range which can be outputted directly by the DDS is narrower.

### Another DDS

FIG. 15 is a diagram illustrating the DDS 51B used in the DDS 51A of FIG. 13(b). The DDS 51B is comprised of a reference clock multiplier 65A, a phase operator 61A, a sine-wave/amplitude converter 62A, a digital multiplier 66A, a D/A converter (DAC) 63A, a frequency/phase/amplitude program register 64A, and a data input register 64B.

The DDS illustrated in FIG. 15 is basically identical, in overall structure to the DDS illustrated in FIG. 14 but is different therefrom in that, since the phase operator 61A, digital multiplier 66A and D/A converter 63A can be operated more quickly than the DDS of FIG. 14, the frequency (170 MHz to 180 MHz) corresponding to the selected wavelength of the wavelength selecting section can be outputted directly by realizing the high speed arithmetic operation through the setting of the reference clock signal to the higher rate.

In FIG. 15, the frequency/phase/amplitude setting information from an external control device is inputted to the data input register 64B as write timing signal, parallel address signal, and parallel data signal. These information signals are then inputted to the frequency/phase/amplitude program register 64A from the data input register 64B, while the phase setting information about the frequency is inputted to the phase operator 61A and the amplitude setting information, to the digital multiplier 66A.

In addition, the reference clock multiplier 65A generates the reference clock signal based on the reference signal from an external circuit of the DDS 51B and then applies the reference clock signal to the phase operator 61A, digital multiplier 66A and D/A converter 63A. The phase operator 61A inputs the phase information of 0 to 2π to the sine-wave/amplitude converter 62A in every reference time based on the reference clock signal. The sine-wave/amplitude converter 62A converts the signal to the amplitude data with reference to a sine-wave look-up table stored in the sine-wave/amplitude converter 62A. Accordingly, the sine-wave/amplitude converter 62A outputs the digital signal of the amplitude information depending on the phase information of 0 to 2π outputted from the phase operator.

The digital multiplier 66A multiplies the digital signal of the sine-wave amplitude information inputted from the sine-wave/amplitude converter 62A and the amplitude value of the amplitude setting information inputted from the frequency/phase/amplitude program register 64A and provides an output to the D/A converter 63A. The D/A converter 63A converts the output digital signal from the digital multiplier 66A to an analog signal and outputs this analog signal as the sine-wave signal.

In the structure of DDS illustrated in FIG. 15, since the amplitude of sine-wave signal to be outputted is determined based on the amplitude information of the sine-wave digital signal and the amplitude setting information of the frequency/phase/amplitude program register, the signal output can be controlled to the predetermined amplitude value without provision of a variable attenuator.

Moreover, since the DDS is capable of outputting directly the frequency (170 MHz to 180 MHz) corresponding to the selected wavelength of the wavelength selecting section, it is not required to provide, in the subsequent stage of DDS, a structure for multiplying the frequency, for example, a multiplier or the like. Accordingly, further reduction in size of the circuit can be realized.

In addition, when it is required to change the output frequency of DDS, since the output signal frequency is changed by changing the phase setting information about the frequency applied to the phase operator 61A with the change of the parallel data signal, the frequency change can be realized more quickly than that when the PLL circuit is used. When the DDS is used as the RF signal source of the wavelength selecting section, the time required for switching of the selected frequency of the wavelength selecting section can be set, for example, to about 1 ms which is about 1000 times shorter than the time required when the PLL is used as the RF signal source of the wavelength selecting section.

### First Embodiment of Wavelength Selecting Operation

Next, operations of the wavelength selection module based on a first, preferred embodiment of the present invention will be described.

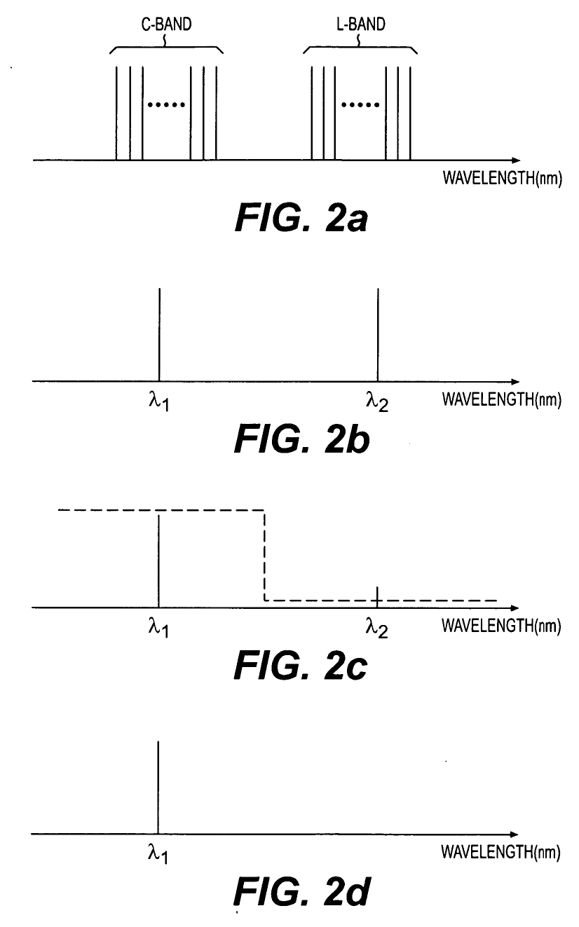

FIG. 1 illustrates the structure of the wavelength selection module of the first embodiment of the present invention. FIGS. 2(a) to 2(d) illustrate the spectra of the lights in the structure in each stage of the wavelength selection module depending on the first embodiment of the present invention, wherein the wavelength is plotted on the horizontal axis, while the light intensity on the vertical axis. FIG. 2(a) illustrates the spectrum of light inputted to the input port of the wavelength selecting section 1A, while FIG. 2(b), illustrates the spectrum of light outputted from the output port of the wavelength selecting section 1A and inputted to the wavelength isolating filter 8A, FIG. 2(c), the spectrum of the light outputted from the wavelength isolating film 8A and inputted to the optical filter 5A, and FIG. 2(d), the spectrum of the light outputted to the outputting (OUT) port of the optical filter 5A, respectively.

In FIG. 1, the WDM signal light inputted to the wavelength selection module is inputted to the input port of the wavelength selecting section 1A. The light inputted to the wavelength selecting section 1A is obtained by the wavelength multiplexing of C-band light and L-band light, as illustrated in FIG. 2(a). The RF signals including a plurality of frequencies are inputted, from the RF signal oscillating sections 2A and 2B, to the RF signal input port of the wavelength selecting section 1A through the mixing section 7A.

When the AOTF illustrated in FIG. 18 is used as the wavelength selecting section 1A, the input port of the wavelength selecting section 1A corresponds to the inputting (IN) port of the AOTF, while the output port of the wavelength selecting section 1A to the dropping (DROP) port of the AOTF. The light of the wavelength corresponding to the frequency of RF signal impressed among the WDM signal lights inputted to the inputting (IN) port of the AOTF is outputted to the dropping (DROP) port through the mode conversion and the lights of the other wavelengths are outputted to the transmitting (THRU) port. The RF signal outputted to the wavelength selecting section 1A from the mixing section 7A is outputted from the RF signal oscillating sections 2A and 2B and the frequency thereof is determined by the control section 3A.

When the frequencies of the RF signals outputted from the RF signal oscillating sections 2A and 2B are assumed respectively as f1 and f2 and the wavelengths of the lights which are converted in the mode when the RF signals of the frequencies f1 and f2 are inputted to the wavelength selecting section 1A are also assumed respectively as λ₁, λ₂, the lights in the wavelengths of 11 and 12 are outputted from the transmitting (THRU) port of the AOTF as the wavelength selecting section 1A.

Here, the frequencies f1 and f2 are determined to bring the wavelength λ₁ into the C-band wavelength region, while the wavelength λ₂ into the L-band wavelength region. Accordingly, the output light from the dropping (DROP) port of the wavelength selecting section 1A can be obtained by multiplexing the light (wavelength λ₁) in the C-band wavelength region and the light (wavelength λ₂) in the L-band wavelength.

Since the wavelength isolating filter 8A outputs the light in the C-band wavelength region to the optical filter 5A and the light in the L-band wavelength region to the optical filter 5B, the light of the wavelength λ₁ is outputted to the optical filter 5A and the light of the wavelength X₂ to the optical filter 5B. A solid line of FIG. 2(c) is the spectrum of the light outputted from the wavelength isolating filter 8A and inputted to the optical filter 5A. Since isolation of the wavelength isolating filter 8A is not perfect, the light in the wavelength λ₁ in the C-band wavelength region and the light in the wavelength λ₂ in the L-band wavelength region are outputted to the optical filter 5A from the wavelength isolating filter 8A.

Since the optical filter 5A is an optical band-pass filter for transmitting only the light in the region of band C and also has the characteristic indicated by the dotted line of FIG. 2(c), the light inputted to the optical filter 5A from the wavelength isolating filter 8A is filtered depending on this characteristic. Therefore, an output of the optical filter 5A is only the light in the wavelength λ₁ and is then outputted to the outputting (OUT) port 1 as illustrated in FIG. 2(d).

Similarly, the light inputted to the optical filter 5B from the wavelength isolating filter 8A is also filtered depending on the characteristic for transmitting only the light in the region of band L of the optical filter 5B and an output of the optical filter 5B is only the light of the wavelength 12 and is then outputted to the outputting (OUT) port 2.

Moreover, since intensity of the light inputted to the monitoring section (MON) 4A is outputted as a digital signal to the control section 3A as illustrated in FIG. 16(a), intensity and frequency of the RF signals outputted from the RF signal oscillating sections 2A and 2B can be controlled using this output digital signal.

### First Embodiment of Selected Wavelength Correcting Operation

In a first embodiment, when temperature of the wavelength selecting section varies and the relationship between the RF signal frequency and selected wavelength is also varied, such variation can be corrected to be able to select the light of the target wavelength by changing the output frequency of the RF signal oscillating section 2A or 2B to utilize the output signal of the monitoring section 4A.

Since the spectrum of selected wavelength of the wavelength selecting section has side lobes in the higher and lower regions of the selected wavelength but intensity of the side lobes are weaker than the light intensity of the selected wavelength, the wavelength corresponding to the RF signal frequency applied to the wavelength selecting section 1A can be recognized as the input light wavelength of the wavelength selecting section with a voltage value of the ADC 31A as the output of the monitoring section 4A. When the AOTF is used as the wavelength selecting section, if the frequency of RF signal applied to the IDT 21A is increased, the wavelength of the SAW propagated through the SAW waveguide 22A becomes short and therefore the wavelength of light selected by the wavelength selecting section also becomes short as illustrated in FIG. 18.

The RF signal frequency and the selected wavelength are in the relationship of inverse proportion and the selected wavelength increases proportionally for a minute reduction of the RF signal frequency. Therefore, the RF signal frequency corresponding to the desired wavelength of the light can be calculated when the RF signal frequency corresponding to the wavelength of light and variation rate of the wavelength of the light for the RF signal frequency can be obtained. Since the variation rate of the wavelength of a certain light for the RF signal frequency almost does not change for temperature, when this value is stored, the RF signal frequency corresponding to the light of the desired wavelength can be obtained by obtaining the RF signal frequency corresponding to the wavelength of a certain light.

Similarly, the frequency of RF signal corresponding to the WDM signal of the other channel can be obtained when the frequency of the RF signal corresponding to the WDM signal of a certain channel and the RF frequency per channel of the WDM signal can be obtained.

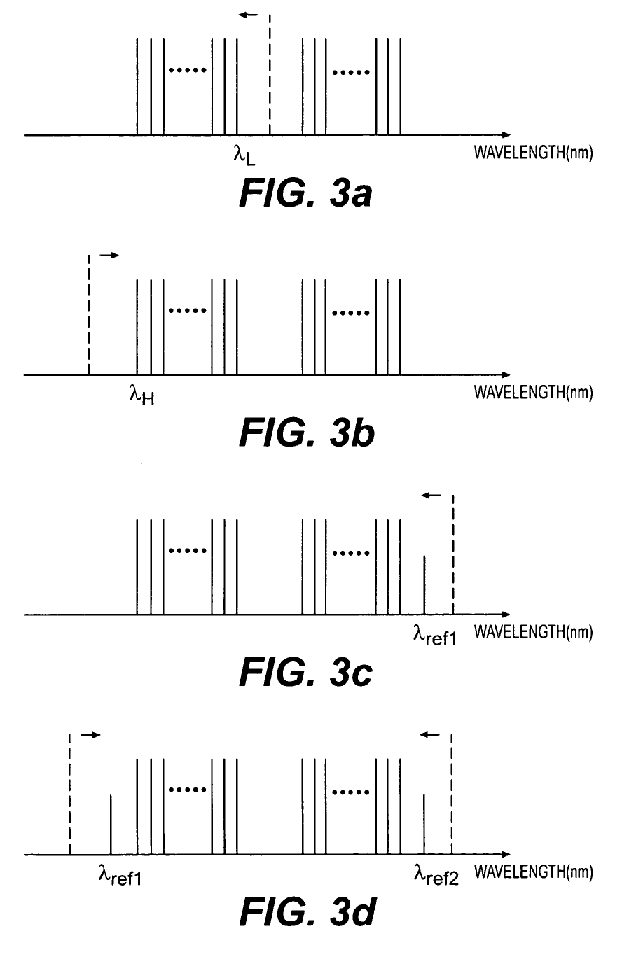

A method of correcting change in the relationship between the RF signal frequency and selected wavelength due to temperature change or the like in the first embodiment will be described with reference to FIG. 3(a).

First, it is assumed that the RF signal of a single frequency is applied to the wavelength selecting section 1A. FIG. 3(a) schematically illustrates the relationship between the WDM signal light and the selected wavelength when the selected wavelength of the wavelength selecting section 1A is reduced from the side of longer wavelength. In this figure, wavelength is plotted on the horizontal axis, while intensity of light on the vertical axis. When the frequency of RF signal outputted from the RF signal oscillating section 2A is increased from 170 MHz in the step of 1 kHz, the selected wavelength of the wavelength selecting section 1A is decreased due to the increase of the RF signal frequency. Accordingly, the selected wavelength of the wavelength selecting section 1A changes in the side of short wavelength as illustrated by the dotted line of FIG. 3(a).

When an output of the monitoring section 4A is set first to the condition to select the input light by increasing the RF signal frequency and changing the selected wavelength of the wavelength selecting section to the side of short wavelength, the frequency of RF signal applied to the wavelength selecting section 1A when the monitoring section 4A provides the peak output is recorded as the RF frequency fL for the longest wavelength. The selected wavelength λ_{L} corresponding to the RF signal in the frequency fL is the wavelength of signal light in the longest wavelength of the WDM signal light as illustrated in FIG. 3(a).

FIG. 3(a) schematically illustrates the relationship between the WDM signal light and the selected wavelength when the selected wavelength of the wavelength selecting section 1A is reduced from the side of the longer wavelength. In this figure, wavelength is plotted on the horizontal axis, while intensity of light on the vertical axis. Next, when frequency of the RF signal outputted from the RF signal oscillating section 2B is reduced from 180 MHz in 1 kHz decrements, the selected wavelength of the wavelength selecting section 1A increases due to reduction of frequency of the RF signal. Therefore, the selected wavelength of the wavelength selecting section 1A changes to the side of longer wavelength as illustrated with the dotted lines of FIG. 3(b).

When an output of the monitoring section 4A is set first to the condition to select the input light by reducing the RF signal frequency and changing the selected wavelength of the wavelength selecting section to the side of longer wavelength, frequency of the RF signal applied to the wavelength selecting section 1A when the monitoring section 4A provides the peak output is recorded as the RF frequency fH corresponding to the longest wavelength. The selected wavelength λ_{L} corresponding to the RF signal in the frequency fL is the wavelength of signal light of the shortest wavelength of the WDM signal light as illustrated in FIG. 3(b).

Since the RF frequency Deltaf per channel of the WDM signal light can be obtained from the number of signals of the WDM signal obtained with the information of the monitor control light which is usually used for the WDM communication and from difference between fL and fH, the RF signal frequency corresponding to the wavelength of the nth signal light from the shortest wavelength can be obtained as fH-(n-1) Deltaf. Accordingly, even when the relationship between the RF signal frequency and selected wavelength is varied due to the temperature change of the wavelength selecting section, such variation can be corrected by utilizing an output of the monitoring section 4A.

As described above, according to the first embodiment of the present invention, the wavelength selection module, which can select and output the lights of two wavelengths not wavelength-multiplexed using only one wavelength selecting section, can be constituted easily.

Moreover, change of relationship between the RF frequency and selected wavelength due to temperature change or the like of the wavelength selecting section can be corrected by recording the number of RF signal frequencies corresponding to the longest wavelength and the shortest wavelength of the WDM signal light and then combining this number of RF signal frequencies with the number of signals of the WDM signal light obtained from the other.

Moreover, when the AOTF is utilized as the wavelength selecting section, the frequency of RF signal must be determined considering the influence such as the attraction effect due to the simultaneous selection for simultaneously selecting the lights of a plurality of wavelengths. However, when the wavelengths of the selected lights are determined, as described in the first embodiment, to bring the wavelength λ₁ to the C-band wavelength region and the wavelength λ₂ to the L-band wavelength region, the influence of attraction is nearly insignificant or inconsequential because the selected wavelengths of these bands are isolated.

### Another Embodiment

FIG. 5 illustrates a wavelength selection module based on another preferred embodiment of the present invention. In this embodiment, the wavelength selection module is comprised of a wavelength selecting section 1A for selecting a plurality of wavelengths, a control section (CTRL) 3A, RF signal oscillating sections (RF OSC) 2A to 2B, a mixing section (Mixer) 7A, monitoring sections (MON) 4A to 4B, optical filters 5C to 5D, and couplers 9A to 9B. Operations of the wavelength selecting section 1A, RF signal oscillating sections 2A to 2B and mixing section 7A are identical to that of the previous embodiment.

In the wavelength selection module of the second embodiment, the AOTF is used as the wavelength selecting section, and the monitor control light is used for correction of the relationship between the frequencies of the RF signals applied to the AOTF and the selected wavelengths of AOTF.

The optical filter 5C is used to attenuate the wavelength of the monitor control light and the monitor control light wavelength is rejected and the lights of the other wavelengths are transmitted so that the monitor control light is not included in the output of the wavelength selection module outputted through the coupler 9B among the lights branched by the coupler 9A.

Meanwhile, the optical filter 5A selectively transmits the light of the monitor control light wavelength from the lights branched by the coupler 9A. The light filtered by this optical filer 5D is inputted to the monitor 4A. Selective transmission of the wavelength of the monitor control light is identical to the transmission of only the wavelength of the monitor control light among the lights outputted from the wavelength selecting section 1A. For example, when the wavelength of monitor control light is shorter than the wavelength of the wavelength-multiplexed signal lights, the low-pass filter can be used and when the monitor control light exists among the wavelengths of the wavelength-multiplexed signal lights, the band-pass filter can be used.

The monitoring section 4A inputs the light demultiplexed by the coupler 9A and filtered by the filter 5D and outputs intensity of the light to the control section 3A as the digital signal. Structure of the monitoring section 4A is similar to that of the monitoring section of the first embodiment and outputs the digital signal related to intensity of the input light obtained by the Log amplifier for current-voltage conversion having wider dynamic range to the control section 3A.

In the second embodiment, since the light of the wavelength corresponding to the RF signal frequency applied is outputted to the coupler 9A with the wavelength selecting section 1A, the lights of the wavelengths other than the wavelength of monitor control light among the lights selected by the wavelength selecting section 1A are included in the output of the coupler 9B and wavelength selection module. Moreover, the monitor control light is inputted to the monitor 4A when the RF signal of the frequency corresponding to the monitor control light wavelength is applied to the wavelength selecting section 1A.

The control section 3A inputs the digital signal outputted from the monitoring section 4A and outputs the control signal for specifying frequency/phase/ amplitude generated by the RF signal oscillating sections 2A and 2B. The control section 3A is constituted as illustrated in FIG. 16(a) as in the case of the first embodiment.

### Operation of the Second Embodiment

Next, operations of the wavelength selection module of the second embodiment of the present invention will be described.

The wavelength selection module according to the second embodiment of the present invention illustrated in FIG. 5 corrects the relationship between the RF signal frequency applied to the AOTF as the wavelength selecting section 1A and the wavelength selected by the AOTF using the monitor control light.

In the second embodiment, the filter 5C for rejecting the monitor control light is provided for the light which becomes the output light of the wavelength selection module among the branching lights of the coupler 9A, while the filter 5D for rejecting the WDM signal light other than the monitor control light is provided for the light inputted to the monitor 4A for monitoring the monitor control light.

Since the filters 5C and 5D are provided, the monitor control light is selected for the monitor 4A with the operation for changing the RF signal applied to the wavelength selecting section 1A in order to select the monitor control light. Meanwhile, any change does not appear in the light which becomes the output light of the wavelength selection module. Accordingly, since the operation for selecting the monitor control light can be performed by giving no influence on the operation to select the WDM signal light, operation to correct the relationship between the RF signal and selected wavelength can be performed independent of the operation to select the WDM signal light.

Therefore, when the time which is allowed to newly select another wavelength is short and the relationship between the RF signal frequency and the selected wavelength cannot be adjusted before the selection of another new wavelength, the correct wavelength can be selected at the time of selecting the light having new wavelength, because the relationship between the RF signal frequency and selected wavelength can always be adjusted even in the wavelength switch used, for example, in the burst switching system.

In FIG. 5, the monitor control light and the WDM signal light inputted to the wavelength selection module are inputted to the wavelength selecting section 1A. The RF signal including a plurality of frequencies is inputted to the RF signal input port of the wavelength selecting section 1A from the RF signal oscillating sections 2A and 2B through the mixing section 7A.

When the AOTF illustrated in FIG. 18 is used as the wavelength selecting section 1A as in the case of the first embodiment, the input port of the wavelength selecting section 1A corresponds to the inputting (IN) port of the AOTF, while the output port of the wavelength selecting section 1A, to the dropping (DROP) port of the AOTF. The light of the wavelength corresponding to the applied frequency of RF signal among the WDM signal lights inputted to the inputting (IN) port of the AOTF is outputted to the dropping (DROP) port through the mode conversion, while the lights of the other wavelengths are outputted to the transmitting (THRU) port. The RF signal outputted to the wavelength selecting section 1A from the mixing section 7A has been outputted from the RF signal oscillating sections 2A and 2B and the frequency thereof is determined with the control section 3A.

When the frequencies of RF signals outputted from the RF signal oscillating sections 2A and 2B are respectively assumed as f1 and f2, while the wavelengths of lights which are subjected to the mode conversion under the condition that the RF signals of frequencies f1 and f2 are inputted to the wavelength selecting section 1A are respectively assumed as λ₁ and λ₂, the lights in the wavelengths λ₁ and λ₂ are outputted from the transmitting (THRU) port of the AOTF as the wavelength selecting section 1A.

In the second embodiment, the wavelengths of one or a plurality of lights outputted from the wavelength selection module are selected and the wavelength of the monitor control light is also selected as the selected wavelengths by utilizing the fact that the wavelength selecting section 1A is capable of selecting a plurality of wavelengths.

The monitor control light is allocated in the wavelength isolated from the wavelength of WDM signal light in order to eliminate adverse effect on the WDM signal light. Moreover, the monitor control light is never eliminated unlike the signal light. Correction of the relationship between the RF signal frequency and selected wavelength under the condition that the wavelength of monitor control light is shorter than the wavelength of WDM signal light will be described below.

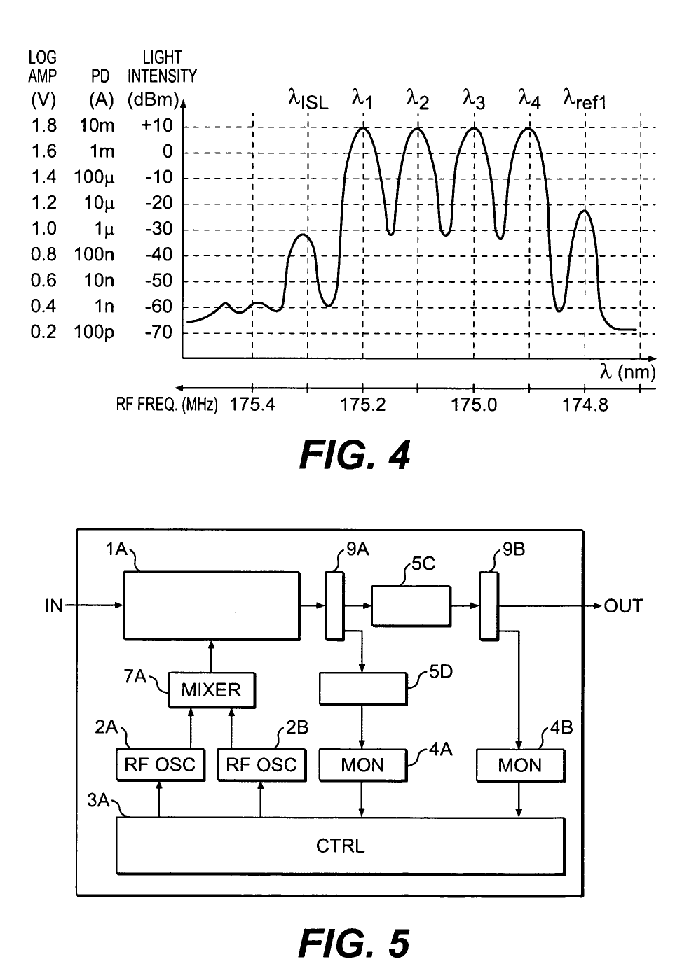

When the AOTF is used as the wavelength selecting section 1A, the selected wavelength of the wavelength selecting section 1A is reduced by increasing the RF frequency to be applied to the wavelength selecting section 1A, as illustrated on the axis under the horizontal axis of the graph of FIG. 4.

When the frequency of RF signal outputted from the RF signal oscillating section 2A is reduced from 180 MHz in decrements of 1 kHz, the selected wavelength of the wavelength selecting section 1A increases due to the phenomenon of the RF signal frequency. Therefore, the selected wavelength of the wavelength selecting section 1A changes to the side of longer wavelength from the side of shorter wavelength.

Since the wavelength of the monitor control light is longer than the shortest wavelength of the WDM signal light, the RF signal frequency is lowered and the selected wavelength of the wavelength selecting section is varied to the side of the longer wavelength. Since the filter 5D transmits only the wavelength of the monitor control light, when intensity of the monitor control light monitored with the monitoring section 4A becomes maximum, the RF signal frequency being applied to the wavelength selecting section 1A is recorded as the RF frequency f-OSC corresponding to the wavelength l-OSC of the monitor control light.

As is described above regarding the first embodiment, when the changing rate of the wavelength of light for the RF signal frequency is stored previously, the RF signal frequency corresponding to the light of desired wavelength can be obtained by obtaining the RF signal frequency corresponding to a certain wavelength of light. In the second embodiment, frequency of each channel of the WDM signal light can be obtained from the monitor control signal or the like. Therefore, the RF signal frequency corresponding to the wavelength of light of each channel of the WDM signal light.

Accordingly, even when the relationship between the RF signal frequency and selected wavelength is changed due to temperature change of the wavelength selecting section, change in the relationship between the RF frequency and selected wavelength can be corrected by utilizing the monitor control light.

Scanning is defined as the operation for discriminating the first maximum value of light intensity by detecting the light signal of the predetermined wavelength with a light intensity detecting means while the RF signal frequency is changed in the first frequency interval, for example, of 1 kHz in view of discriminating the RF signal frequency which results in the maximum light intensity as described above.

With the scanning operation described above, change in the relationship between the RF frequency and selected wavelength can be corrected with the tracking process described below for the characteristic change of the wavelength selecting section 1A after detection of the RF signal frequency f-OSC corresponding to the monitor control light.

Frequency tracking is defined as the periodical operation for searching the frequency which results in the maximum intensity of the selected and monitored light through fine variation of the frequency applied to the AOTF before and after the RF frequency corresponding to the target wavelength of light. The RF frequency corresponding to the target wavelength of the light changes due to the characteristic change of the AOTF depending on changes of the atmosphere such as temperature change and change by aging. However, the RF frequency corresponding to the wavelength of monitor control light can be obtained following such changes by performing frequency tracking after the target light is selected with the scanning operation.

In the second embodiment, since the filter 5C is provided, the monitor control light is never outputted to the outputting (OUT) port of the wavelength selection module even when such monitor control light is selected by the wavelength selecting section 1A. Accordingly, even when the scanning and tracking operations are performed to obtain the RF frequency corresponding to the monitor control light, any adverse effect is never applied on the output (OUT) of the wavelength selection module. Therefore, since the relationship between the RF signal frequency and selected wavelength can always be adjusted by updating the relationship between the monitor control light wavelength and the RF signal frequency with the tracking operation in the constant interval and also by updating the relationship between the RF signal frequency and the selected wavelength of the wavelength selecting section 1A, the correct wavelength can be selected at the time of selecting the light of new wavelength.

Therefore, when the wavelength selecting section selects the WDM signal light, the target signal light can be selected continuously with the tracking operation. Moreover, when the WDM signal light of new wavelength is selected, the new target signal light can be selected with the relationship between the RF signal frequency and the selected wavelength which has been updated by the tracking of the monitor control light.

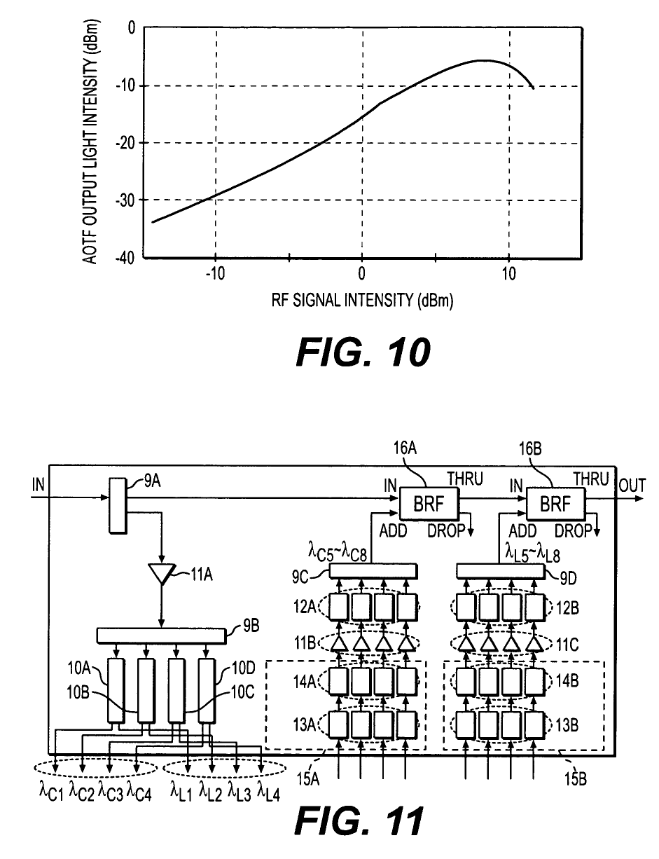

As described above, when the wavelength is selected with the AOTF, the selected wavelength is changed with the applied frequency of RF signal. Moreover, when the applied RF signal frequency is changed, intensity of the light in the selected wavelength (selected light) also changes. FIG. 10 illustrates the relationship between the intensity of RF signal and the intensity of selected light.

As illustrated in FIG. 10, intensity of the selected light becomes maximum at the particular RF signal intensity. Power tracking is defined as the operation for searching intensity of the RF signal resulting in the maximum intensity of the monitored and selected light by changing the intensity of RF signal in the RF frequency corresponding to the target wavelength of the light.

When the WDM signal light is selected with the wavelength selecting section 1A, the RF signal is controlled to the frequency and intensity of the RF signal which results in the maximum optical output corresponding to the target wavelength of light by executing the frequency tracking and power tracking operations.

In the second embodiment, since the filter 5C is provided, the monitor control light is never outputted to the output (OUT) of the wavelength selection module even. when this monitor control light is selected by the wavelength selecting section 1A. Here, the filter characteristic for the monitor control light wavelength of the filter 5C can be lowered and insertion loss of the filter 5C can also be suppressed by utilizing the relationship between the RF signal intensity and output light intensity of FIG. 10.

Namely, it is enough for the monitoring section 4A to monitor the intensity of monitor control light but the monitoring section 4A is never required to monitor the signal included in the monitor control light. Accordingly, intensity of the monitor control light by the wavelength selecting section 1A is not required to have the intensity as high as that required for selecting the WDM signal light.

Intensity of the light outputted from the wavelength selecting section 1A can be lowered by reducing the intensity of RF signal as illustrated in FIG. 10. Intensity of the monitor control light inputted to the filter 5C is reduced by lowering intensity of the RF signal corresponding to the monitor control light wavelength and suppressing output of the monitor control light by the wavelength selecting section 1A up to the intensity enough for monitoring the monitor control light with the monitoring section 4A. Accordingly, since the monitor control light is not outputted to the output of wavelength selection module, the filter characteristic for the monitor control light wavelength required for the filter 5C is lowered. Thus, filter insertion loss for the WDM signal light can be suppressed.

According to the second embodiment, as described above, the wavelength selection module can be constituted, in which the relationship between the RF signal frequency and selected wavelength changed due to temperature change of the wavelength selecting section can be corrected by selecting the monitor control light and the light of the target wavelength and by continuously selecting the monitor control light with the scanning and tracking operations. Moreover, the light of the target wavelength can be switched freely.

### Third Embodiment

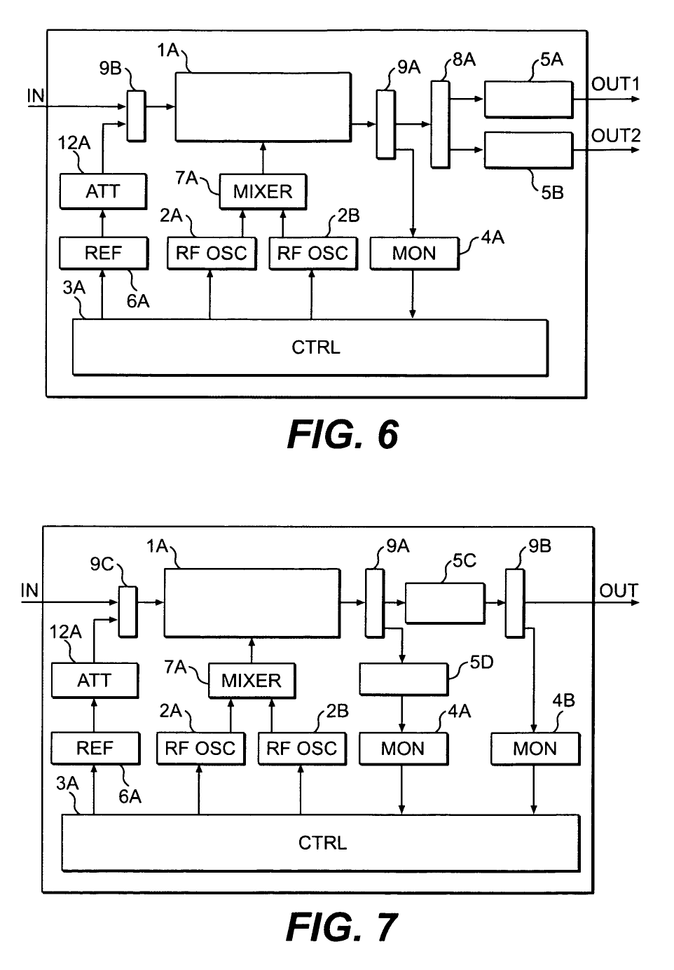

FIG. 6 illustrates a wavelength selection module according to the third embodiment of the present invention. The wavelength selection module according to the third embodiment is comprised of a wavelength selecting section 1A for selecting a plurality of wavelengths, a control section (CTRL) 3A, RF signal oscillating sections (RF OSC) 2A to 2B, a mixing section (Mixer) 7A, monitoring sections (MON) 4A to 4B, a reference light generating section (REF) 6A, an optical attenuator (ATT) 12A, couplers 9A and 9B, and a wavelength isolating filter 8A. Structures and operations of the wavelength selecting section 1A, RF signal oscillating sections 2A to 2B, mixing section 7A, coupler 9A, monitoring section 4A, wavelength isolating filter 8, and optical filters 5A to 5B are identical to those of the first embodiment.

The reference light outputted from the reference light generating section 6A is used to correct the phenomenon that the selected wavelength of the wavelength selecting section 1A changes due to the ambient temperature. The reference light generating section is provided with a built-in mechanism for making constant the wavelength of output lights. Even when the relationship between the RF signal frequency and the selected wavelength of the wavelength selecting section is changed due to the change of temperature of the wavelength selecting section, the relationship between the RF signal frequency and the selected wavelength of the wavelength selecting section can be obtained and corrected by changing the RF signal frequency to select the output light of the reference light generating section. An output of the reference light generating section 6A is adjusted in light intensity with the ATT 12A, multiplexed with the input light of the wavelength selection module with the coupler 9A and is then inputted to the input port of the wavelength selecting section 1A.

The monitoring section 4A inputs the light demultiplexed with the coupler 9A and outputs intensity of the same light as a digital signal to the control section 3A. The structure of the monitoring section 4A is similar to the monitoring section in the first embodiment and this monitoring section 4A outputs, to the control section 3A, the digital signal related to input light intensity obtained from a Log amplifier for current-voltage conversion having wider dynamic range.

In the third embodiment, the light multiplexing the input light of the wavelength selection module and the reference light is inputted to the input port of the wavelength selecting section 1A. Therefore, the light in the wavelength corresponding to the RF signal frequency applied to the wavelength selecting section 1A among the lights multiplexing the input light of the wavelength selection module and the reference light is inputted to the monitoring section 4A.

The control section 3A inputs the digital signal outputted from the monitoring section 4A and outputs the control signals for specifying frequency/amplitude/phase generated by the RF signal oscillating sections 2A and 2B. The control section 3A is constituted as illustrated in FIG. 16(b) like that in the first embodiment.

### The Reference Light Generating Section

As illustrated in FIG. 17, the reference light generating section 6A is formed of a laser diode (LD) section 42A having the wavelength fixing function and a control circuit thereof. Within the LD section 42A, a photo-diode (PD) 36A for receiving an output light of an LD 35A and a PD 36B for receiving the light obtained by filtering the output light of the LD 35A with a filter 37A are monitoring the output light of the LD 35A. Output currents of the PDs 36A and 36B are converted respectively to voltages with PD monitoring circuits (PD MON) 34A and 34B, then converted respectively to digital signals with A/D converters (ADC) 31B and 31C, and the inputted to the control section 3B.

Moreover, temperature of the LD section 42A is always monitored with a temperature control section (TEM CTRL) 41A through a thermistor 38A and the temperature control section 41A controls temperature of the LD section 42A with a temperature control circuit 39A (TEC) through a temperature control circuit driver (TEC DRV) 40A. Temperature information of the LD section 42A monitored with the temperature control section is converted to a digital signal with the A/D converter 31A and is then inputted to the control section 3A.

The control section 3B obtains output current information of the PDs 36A and 36B within the LD section 42A through the A/D converters 31B and 31C. Therefore, the control section 3B controls the temperature control section 41A to change temperature of the LD section 42A through the D/A converter 32A in order to provide the constant wavelength of the output light from the LD 35A. Moreover, the control section 3B is also capable of controlling the current flowing into the LD 35A in order to change intensity of the output light of the LD section 42A by controlling the LD driver (LD DRV) 33A through the D/A converter 32B.

When the reference light generating section illustrated in FIG. 17 is used in combination with external devices, the control section 3B of FIG. 17 may be different, in FIG. 5, from the control section 3A of FIG. 5 and the control section 3A of FIG. 5 may also be used as the control section 3B of FIG. 17.

### Operation of the Third Embodiment

Next, the wavelength selection module according to the third embodiment of the present invention will be described.

The wavelength selection module according to the third embodiment of the present invention illustrated in FIG. 6 can be achieved by adding a structure for multiplexing the reference light to the wavelength selecting section input of the wavelength selection module of the first embodiment.

In the third embodiment, since the filters 5C and 5D are provided, as in the case of the second embodiment, the operation to change the RF signal applied to the wavelength selecting section 1A to select the reference light can be achieved without resulting in the influence on the operation to select the WDM signal light. Accordingly, the operation to correct the relationship between the RF signal and selected wavelength can be realized independent of the operation to select the WDM signal light.

In FIG. 6, the reference light outputted from the reference light oscillating section 6A and the input light of the wavelength selection module are multiplexed with the coupler 9A and are then inputted to the input port of the wavelength selecting section 1A. The wavelength selecting section 1A selects the light of the wavelength corresponding to the RF signal frequency applied from the mixing section 7A among the input lights and then outputs the selected light to the coupler 9A.

In the third embodiment, when the relationship between the RF signal frequency and selected wavelength is changed due to the change of temperature of the wavelength selecting section, the relationship between the RF signal frequency and selected wavelength can be corrected by detecting the reference light outputted from the reference light oscillating section 6A with the monitoring section 4A.

FIG. 4 illustrates spectrum intensity inputted to the monitoring section 4A for the wavelength. In the third embodiment, the wavelength of the reference light outputted from the reference light oscillating section 6A is defined as λ_{ref1}, while the wavelength λ_{ref1} of the reference light is assumed to be longer than the longest wavelength of the signal light. Moreover, the reference light oscillating section 6A and ATT 12A are set to observe the reference light, with the monitoring section 4A, in the intensity lower than the signal light and higher than the side lobe intensity of the signal light.

As illustrated in the lower axis of the horizontal axis of the graph of FIG. 4, the selected wavelength of the wavelength selecting section 1A is reduced by increasing the RF frequency applied to the wavelength selecting section 1A. Therefore, the spectrum illustrated in FIG. 4 can be obtained by observing an output of the monitoring section 4A by changing an output of the RF signal oscillating section 2A.

In FIG. 4, λ₁ to λ₄ designate the signal lights selected by the wavelength selecting section 1A, λ_{1SL}, side lobe in the short wavelength side of the signal light in the wavelength λ₁, and λ_{ref1} peak position when the reference light is detected with the monitoring section 4A, respectively. Moreover, the vertical graduation numerals in the right side designate intensity of light inputted to the output (OUT) of the wavelength selection module, graduation numerals in the center designate current values by the light branched by the coupler 9A or 9B and is then inputted to the PD 55A (FIG. 16(a)) of the monitoring section 4A or 4B. The graduation numerals on the left side designate output voltages of the Log amplifier 56A (FIG. 16(a)) for current—voltage conversion. The light in the wide intensity range from the intensified light to the minute intensity level can be converted to the input range of the A/D converter 31A and is then transferred to the control section 3A by using the Log amplifier 56A.

A method of correcting the relationship between the RF signal frequency and selected wavelength will be described with reference to FIG. 3(c) and FIG. 4.

In the third embodiment, only one RF signal frequency is inputted to the wavelength selecting section 1A as in the case of the first embodiment. FIG. 3(c) schematically illustrate the relationship between the WDM signal light and selected wavelength when the selected wavelength of the wavelength selecting section 1A is reduced to the shorter wavelength side from the longer wavelength side, with the wavelength plotted on the horizontal axis and light intensity plotted on the vertical axis. When the RF signal frequency outputted from the RF signal oscillating section 2A is increased from 170 MHz in 1 kHz increments, the selected wavelength of the wavelength selecting section 1A is reduced due to the increase of the RF signal frequency. Therefore, the selected wavelength of the wavelength selecting section 1A changes to the shorter wavelength side from the longer wavelength side as illustrated with the dotted line of FIG. 3(a).

As described above, since the reference light is observed with the monitoring section 4A in the intensity lower than that of the signal light but is higher than the side lobe intensity of the signal light and shows the spectrum indicated by lref1 of FIG. 4, the side lobe of the reference light is never recognized as the signal light with the control section 3A. Moreover, since the side lobe of the reference light is lower than the intensity of side lobe, the reference light is never recognized as the side lobe of the signal light.

Since the wavelength λ_{ref1} of the reference light is longer than the longest wavelength of the WDM signal light, the reference light of the wavelength selecting section is monitored first by increasing the RF signal frequency and thereby to change the selected wavelength of the wavelength selecting section to the shorter wavelength side. When the intensity of the reference light monitored by the monitoring section 4A reaches a maximum, the RF signal frequency applied to the wavelength selecting section 2A is recorded as the RF signal frequency fref1 corresponding to the wavelength λ_{ref1} of the reference light.

As is described regarding the first embodiment, when the changing rate of optical wavelength for the RF signal frequency is stored previously, the RF signal frequency corresponding to the light of the desired wavelength can be obtained by obtaining the RF signal frequency corresponding to the light of a certain wavelength. In the third embodiment, since each channel frequency of the WDM signal light can be obtained from a monitor control signal or the like, the RF signal frequency corresponding to each channel wavelength of the WDM signal light can be obtained by detecting the RF signal frequency when the reference light is selected.

Accordingly, even when the relationship between the RF signal frequency and selected wavelength is changed due to temperature change of the wavelength selecting section, change of the relationship between the RF signal frequency and selected wavelength can be corrected by utilizing the reference light.

In above description, the monitoring section 4A can detect the reference light by changing the selected wavelength of the wavelength selecting section 1A to the shorter wavelength side from the longer wavelength side under the condition that the wavelength lrefl of the reference light is assumed longer than the longest wavelength of the signal light. Change of relationship between the RF signal frequency and selected wavelength can be corrected with the similar method even when the monitoring section 4A detects the reference light by changing the selected wavelength of the wavelength selecting section 1A to the longer wavelength side from the shorter wavelength side under the condition, on the contrary, that the wavelength λ_{ref1} of the reference light is assumed shorter than the shortest wavelength of the signal light.

As described above, according to the third embodiment, the wavelength selection module can be constituted easily. Thereby, two light signals of the wavelengths not yet multiplexed can be selected and outputted using only one wavelength selecting section by multiplexing the reference light to the input light and simultaneously the relationship between the RF signal frequency and selected wavelength changed due to temperature change of the wavelength selecting section can also be corrected.

### Fourth Embodiment

FIG. 7 illustrates the wavelength selection module according to the fourth embodiment of the present invention. The wavelength selection module of the fourth embodiment is comprised of a wavelength selecting section 1A which can select a plurality of wavelengths, a reference light oscillating section (REF) 6A, an optical attenuator (ATT) 12A, a control section (CTRL) 3A, RF signal oscillating sections (RF OSC) 2A to 2B, a mixing section (Mixer) 7A, monitoring sections (MON) 4A to 4B, optical filters 5C to 5D and couplers 9A to 9C. Operations of the wavelength selecting section 1A, RF signal oscillating sections 2A to 2B, mixing section 7A, couplers 9A to 9B are similar to that of the second embodiment. Moreover, structures and operations of the reference light oscillating section 6A and optical attenuator 12A are similar to that of the third embodiment.

The wavelength selection module according to the second embodiment of the present invention illustrated in FIG. 7 is capable of correcting the relationship between the RF signal frequency applied to the AOTF as the wavelength selecting section 1A and the selected wavelength of AOTF using the reference light outputted from the reference light oscillating section 6A.

The optical filter 5C attenuates the wavelength of the reference light to reject the reference light wavelength among the lights branched by the coupler 9A so that the reference light is not included in the output of the wavelength selection module outputted through the coupler 9B, but transmits the lights of the other wavelengths.

Meanwhile, the optical filter 5D selectively transmits the light of the reference light wavelength. The filtered light is then inputted to the monitor 4A. Selective transmission of the reference light wavelength means that only the reference light wavelength among the lights outputted from the wavelength selecting section 1A is transmitted. For example, when the reference light wavelength is shorter than the wavelength-multiplexed signal light wavelength, a low-pass filter may be used, and when the reference light exists between the wavelength-multiplexed signal light wavelengths, a band-pass filter may be used.

In the fourth embodiment, since the light of the wavelength corresponding to the RF signal frequency being applied is outputted to the coupler 9A from the wavelength selecting section 1A, the light of the wavelength other than the reference light wavelength among the selected light of the wavelength selecting section 1A is outputted as the output of the coupler 9B and wavelength selection module. Moreover, when the RF signal of the frequency corresponding to the reference light wavelength is applied to the wavelength selecting section 1A, the reference light is inputted to the monitor 4A.

As in the case of the second embodiment, since the operation to change the RF signal applied to the wavelength selecting section 1A can be performed by giving no influence on the operation to select the WDM signal in order to select the reference light through the provision of the filters 5C and 5D, operation to correct the relationship between the RF signal and selected wavelength can be performed independent of the selecting operation of the WDM signal light.

### Fifth Embodiment

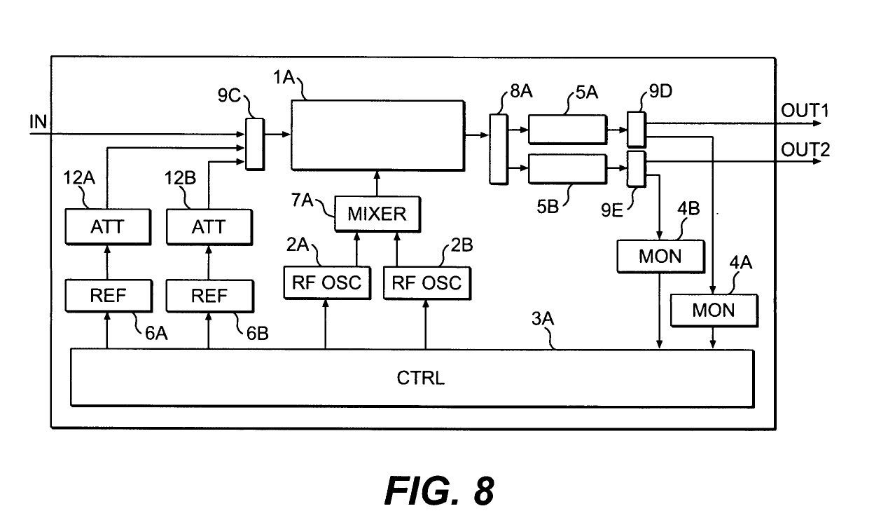

Next, FIG. 8 illustrates a wavelength selection module of the fifth embodiment of the present invention. The wavelength selection module of the fifth embodiment is comprised of a wavelength selecting section 2A, a control section (CTRL) 3A, RF signal oscillating sections (RF OSC) 2A to 2B, a mixing section (Mixer) 7A, monitoring sections (MON) 4A to 4B, a wavelength isolating filter 8A as a wavelength-demultiplexing means, couplers 9C to 9E, optical filters 5A to 5B, reference light oscillating section (REF) 6A to 6B and optical attenuators (ATT) 12A to 12B. Structures and operations of the wavelength selecting section 1A, RF signal oscillating sections 2A to 2B, mixing section 7A, wavelength isolating filter 8A and optical filters 5A to 5B are similar to that of the first embodiment.

The first and second reference lights outputted from the reference light oscillating sections 6A and 6B are used for correcting the phenomenon in which the selected wavelength of the wavelength selecting section 1A is changed due to the ambient temperature. Since the reference light oscillating section is provided with a built-in mechanism to keep constant the wavelength of output light, this reference light oscillating section can obtain and correct the relationship between the RF signal frequency and the selected wavelength of wavelength selecting section by changing the RF signal frequency to select the output light of the reference light oscillating section even when the relationship between the RF signal frequency and the selected wavelength of the wavelength selecting section due to the change of temperature of the wavelength selecting section.

In the fifth embodiment, since the relationship between the reference light and RF signal frequency is corrected independently with the monitors 4A and 4B by multiplexing the first and second reference lights outputted from the reference light oscillating sections 6A and 6B to the input light of the wavelength selection module and then inputting the multiplexed lights to the wavelength selecting section 1A, the relationship between the RF signal frequency and selected wavelength can be obtained accurately and the change of the selected wavelength of the wavelength selecting section 1A due to the ambient temperature can be corrected more accurately.

The first and second reference lights outputted from the reference light oscillating sections 6A and 6B are respectively adjusted in the light intensity with the ATTs 12A and 12B, multiplexed with the input light of the wavelength selection module with the coupler 9C and are then inputted to the wavelength selecting section 1A.

The wavelength isolating filter 8A isolates the output from the coupler 9A to the optical filters 5A and 5B as in the case of the first embodiment. The wavelength isolating filter of the fifth embodiment demultiplexes and outputs the light in the C-band wavelength region among the light outputted from the coupler 9A to the optical filter 5A, while the light in the L-band wavelength region to the optical filter 5B.

The optical filter 5A transmits only the light in the C-band region and attenuates the light in the region other than that of C-band demultiplexed by the wavelength isolating filter 8A. Therefore, only C-band light selected by the wavelength selecting section 1A is outputted to the outputting (OUT) port 1 of the optical filter.

Similarly, the optical filter 5B transmits only the light in the L-band region and attenuates the light in the region other than L-band demultiplexed by the wavelength isolating filter 8A. Therefore, only L-band light selected by the wavelength selecting section 1A is outputted to the outputting (OUT) port 2 of the optical filter.

The monitoring sections 4a and 4B input the output lights of the optical filters 5A and 5B branched from the couplers 9D and 9E and output intensity thereof to the control section 3A as the digital signal. Structures of the monitoring sections 4A and 4B are similar to the monitoring section in the first embodiment and these monitoring sections 4A and 4B output, to the control section 3A, the digital signal related to the input light intensity obtained from the Log amplifier for current-voltage conversion having wider dynamic range.

The control section 3A inputs the digital signal outputted from the monitoring sections 4A and 4B and outputs the control signal for regulating frequency/frequency/phase generated from the RF signal oscillating sections 2A and 2B. The control section 3A is constituted as illustrated in FIG. 16(b) like the first embodiment.

### Operation Of The Fifth Embodiment

Next, operations of the wavelength selection module of the fifth embodiment of the present invention will be described.

In the wavelength selection module according to the fifth embodiment of the present invention illustrated in FIG. 8, the input WDM signal light is multiplexed with the first and second reference lights outputted from the reference light oscillating sections 6A and 6B and is then inputted to the wavelength selecting section 1A.

The RF signal frequencies outputted from the RF signal oscillating sections 2A and 2B are defined respectively as f1 and f2, and wavelengths of lights converted in the mode and outputted from the dropping (DROP) port when the RF signals of frequencies f1 and f2 are inputted to the wavelength selecting section 1A are also defined as λ₁ A and λ₂.

When the frequencies f1 and f2 are determined to bring the wavelength λ₁ to the C-band wavelength bandwidth, while the wavelength λ₂ to the L-band wavelength bandwidth L, since the wavelength isolating filter 8A is the coupler to output the light in the C-band wavelength region to the optical filter 5A and the light in the L-band wavelength region to the optical filter 5B, the light in the wavelength λ₁ is outputted to the optical filter 5A, while the light in the wavelength λ₂ is outputted to the optical filter 5B.

Since the optical filter 5A transmits only light in the C-band region, while the optical filter 5B transmits only light in the L-band region, the light in the wavelength λ₁ is outputted to the outputting (OUT) port 1 and the monitoring section 4A via the optical filter 5A, while the light in the wavelength λ₂ to the outputting (OUT) port and the monitoring section 4B via the optical filter 5B.

Accordingly, the monitoring section 4A outputs, as the digital signal, intensity of the light in the wavelength λ₁ in the C-band wavelength bandwidth among the lights selected by the wavelength selecting section 1A to the control section 3A, while the monitoring section 4B outputs, as the digital signal, intensity of the light in the wavelength λ₂ in the L-band wavelength bandwidth among the lights selected by the wavelength selecting section 1A to the control section 3A.

Accordingly, in the fifth embodiment, the control section 3A can independently and simultaneously obtain intensity of light in the wavelength λ₁ and intensity information of light in the wavelength λ₂ from the information of monitoring sections 4A and 4B.

A method of correcting the relationship between the RF signal frequency and selected wavelength will be described with reference to FIG. 3(d).

In the fifth embodiment, the reference lights outputted from the reference light oscillating sections 6A and 6B are respectively defined as the reference light 1 and 2, while the wavelengths of the reference lights 1 and 2 are respectively defined as λ_{ref1} and λ_{ref2}. Moreover, it is also assumed that the wavelength λ_{ref1} of the reference light 1 is defined shorter than the shortest wavelength of the signal light and can be transmitted by the optical filter 5A, while the wavelength λ_{ref2} of the reference light 2 is defined longer than the longest wavelength of the signal light and can be transmitted by the optical filter 5B.

Moreover, as in the case of the third embodiment, the reference light oscillating section 6A, ATT 12A and reference light oscillating section 6B, ATT 12B are respectively set so that the reference light and reference light 2 are respectively monitored with the monitoring section 4B in the intensity which is lower than that of signal light but is higher than the side lobe of the signal light.

FIG. 3(d) typically illustrates the relationship between the WDM signal light and selected wavelength when one wavelength of the selected wavelengths of the wavelength selecting section 1A is reduced to the shorter wavelength side from the longer wavelength side and one wavelength of the selected wavelengths is increased to the longer wavelength side from the shorter wavelength side, with the wavelength plotted on the horizontal axis and light intensity plotted on the vertical axis. The monitoring section 4A detects the reference light 1 by changing the output signal frequency f1 of the RF signal oscillating section 2A to the low frequency side from the high frequency side and changing the selected wavelength 11 of the wavelength selecting section 1A to the longer wavelength side from the shorter wavelength side. Similarly, the monitoring section 4B detects the reference light 2 by changing the output signal frequency f2 of the RF signal oscillating section 2B to the high frequency side from the low frequency side and by changing the selected wavelength λ₂ of the wavelength selecting section 1A to the short wavelength side from the long wavelength side.

In the fifth embodiment, the light in the C-band wavelength region and the light in the L-band wavelength region can respectively be monitored independently and simultaneously with the monitoring sections 4A and 4B. Similarly, since the RF signal frequencies outputted from the RF signal oscillating sections 2A and 2B can be changed and outputted independently, the RF signal frequency fref1 which results in λ_{ref1}=l1 and the RF signal frequency fref2 which results in λ_{ref2}=l2 can be searched independently and simultaneously with the monitoring sections 4A and 4B.

Accordingly, since the frequency fref1 of the RF signal when the wavelength selecting section 1A selects λ_{ref1}and the frequency fref2 of the RF signal when the wavelength selecting section 1A selects λ_{ref2} can be obtained, a changing rate of the wavelength of light for the RF signal frequency can be obtained and even when the changing rate is not stored previously, the RF signal frequency corresponding to the target wavelength of light can also be obtained.

Moreover, since each channel frequency of the WDM signal light can be obtained from a monitor control signal or the like as in the case of the third embodiment, the RF signal frequency corresponding to the wavelength of each channel light of the WDM signal light can also be obtained in the fifth embodiment.

In the fifth embodiment, it is no longer required to use a changing rate of the wavelength of light for the RF signal frequency because the changing rate of wavelength of the light for the RF signal frequency can be obtained in direct. Therefore, the fifth embodiment has the merit that it is not required to correct, with the other means such-as the tracking, the deviation of the calculated RF signal frequency and deviation of the selected wavelength due to separation of the changing rate stored previously from the actual changing rate.

Moreover, since the wavelengths of the reference light 1 and reference 2 are searched independently and simultaneously with the monitoring sections 4A and 4B, the search time can be kept almost within the range required when only wavelength is searched, even when the wavelength is searched for two reference lights.

According to the fifth embodiment of the present invention, the wavelength selection module can be constituted easily, in which the lights of two wavelengths not yet wavelength-multiplexed can be selected and outputted using only one wavelength selecting section by multiplexing two reference lights to the input light and then monitoring the outputs demultiplexed for each wavelength bandwidth and simultaneously change of the relationship between the RF signal frequency and selected wavelength due to temperature change of the wavelength selecting section can be corrected more accurately using two reference lights.

### Sixth Embodiment

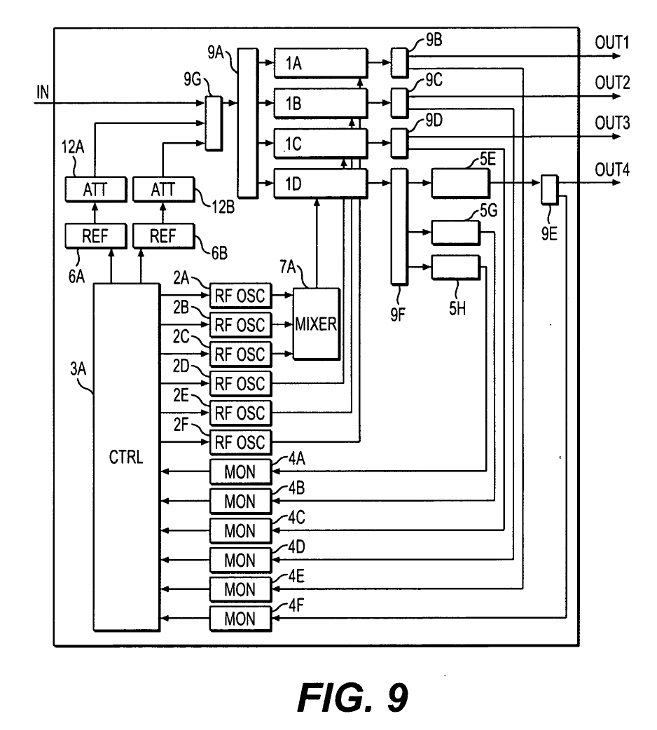

FIG. 9 illustrates a wavelength selection module of the sixth embodiment of the present invention. The wavelength selection module according to the sixth embodiment is comprised of wavelength selecting sections 1A to 1D, a control section (CTRL) 3A, RF signal oscillating sections (RF OSC) 2A to 2F, a mixing section (Mixer) 7A, monitoring sections (MON) 4A to 4F, couplers 9A to 9G, optical filters 5A to 5B, reference light oscillating sections (REF) 6A to 6B, and optical attenuators (ATT) 12A to 12B.

The wavelength selecting sections 1A to 1D of FIG. 9 are placed under the identical environment and an integrated AOTF array, for example, may be used.

As in the case of the fifth embodiment, the first and second reference lights outputted from the reference light oscillating sections 6A to 6B can be used for correcting change in the selected wavelength of the wavelength selecting section 1D due to the temperature change. Since the reference light oscillating section is provided with a built-in mechanism for keeping the wavelength of output light to the constant value, this reference light oscillating section is capable of obtaining and correcting the relationship between the RF signal frequency and selected wavelength of wavelength selecting section by changing the RF signal frequency to select the output light of the reference light oscillating section even when the relationship between the RF signal frequency and selected wavelength of the wavelength selecting section is changed due to the temperature change of the wavelength selecting section.

In the sixth embodiment, the first and second reference lights outputted from the reference light oscillating sections 6A and 6B are multiplexed to the input light of the wavelength selection module with the coupler 9G and thereafter demultiplexed with the coupler 9A. Moreover, since the output light of the wavelength selecting section 1D for selecting the reference light is demultiplexed with the coupler 9F and the relationship between the reference light and the RF signal frequency is corrected respectively with the monitors 4A and 4B independently, accurate relationship between the RF signal frequency and selected wavelength can be obtained and change of the selected wavelengths of the wavelength selecting sections 1A to 1D due to the temperature change can be corrected more accurately.

The first and second reference lights outputted from the reference light oscillating sections 6A and 6B are respectively adjusted in the light intensity with the ATTs 12A and 12B, multiplexed to the input light of the wavelength selection module with the coupler 9G, demultiplexed with the coupler 9A and are then inputted to the wavelength selecting sections 1A to 1D.

The wavelength selecting sections 1A to 1C select the lights in the wavelengths corresponding to the RF signal frequencies outputted respectively from the RF signal oscillating sections (RF OSC) 2D to 2F and output these lights as the outputs (OUT1 to OUT3) of the wavelength selection module. Outputs of the wavelength selecting sections 1A to 1C are branched by the couplers 9B to 9D and are monitored with the monitoring sections (MON) 4A to 4C.

Meanwhile, the relationship between the RF signal frequency and selected wavelength of the wavelength selecting section can be obtained and corrected as in the case of the fourth embodiment by impressing the RF signal through the mixing section 7A to select the signal light of the target wavelength and the first and second reference lights with the wavelength selecting section 1D.

The optical filter 5E attenuates the wavelength of the second reference light. This optical filter 5E rejects the wavelengths of the first and second reference lights and transmits the lights of the other wavelengths so that the first and second reference lights are not included to the output (OUT4) of the wavelength selection module outputted through the coupler 9E among the lights branched by the coupler 9F.

Meanwhile, the optical filters 5G and 5H selectively transmit the lights in the wavelengths of the first and second reference lights from the light branched by the coupler 9F. The filtered lights are respectively inputted to the monitoring sections 4B and 4A.

Accordingly, when the RF signal is applied through the mixing section 7A to select the light of the target wavelength, first and second reference lights with the wavelength selecting section 1D, the signal light in the target wavelength among the output lights branched by the coupler 9F is outputted to the OUT4, while the first and second reference lights are respectively outputted to the monitoring sections 4B and 4A.

In the sixth embodiment, the wavelength selecting section 1D and control section 3A continuously select, as in the case of the second and fourth embodiments, the first and second reference lights with the scanning and tracking processes and corrects the relationship between the RF signal frequency and selected wavelength changed due to the temperature change of the wavelength selecting section 1D and also switches the wavelength of light to the target wavelength.

Moreover, since the wavelength selecting sections 1A to 1D are placed under the identical environment and it can be thought that difference in the relationship between the RF signal frequency and selected wavelength due to the temperature change of the wavelength selecting section does not almost exist, the relationship between the RF signal frequency and selected wavelength of the wavelength selecting sections 1A to 1D can be corrected by correcting the relationship between the RF signal frequency and selected wavelength of the wavelength selecting section 1D.

Accordingly, a plurality of wavelength selecting section can be corrected and cost reduction can also be realized by controlling only one wavelength selecting section to realize correction of the relationship between the RF signal frequency and selected wavelength.

### Seventh Embodiment

FIG. 11 illustrates an OADM device according to the seventh embodiment of the present invention. The OADM device of the seventh embodiment is comprised of optical couplers 9A to 9D, optical amplifiers 11A to 11I, wavelength selection modules 10A to 10D, transponder sections 15A to 15B, optical attenuators (ATT) 12A to 12H, and band-rejection filters (BRFs) 16A to 16B. Moreover, the transponder section 15A is comprised of the optical receivers 13A to 13D and optical transmitters 14A to 14D, while the transponder section 15B is comprised of optical receivers 13E to 13H and optical transmitters 14E to 14H.

The wavelength selection modules 10A to 10D of the present invention utilize the wavelength selecting section and thereby selects and outputs one wavelength in total of two wavelengths respectively from the C-band and L-band wavelength bandwidths.

The BRFs 16A and 16B utilize the rejection function of the wavelength selecting section and output the light corresponding to the applied RF signal frequency among the lights inputted from the adding (ADD) port to the transmitting (THRU) port. Moreover, the BRFs 16A and 16B output the light corresponding to the applied RF signal frequency to the dropping (DROP) port but do not transmit the light to the transmitting (THRU) port.

There is described below the operations in the OADM device illustrated in FIG. 11 that the lights in the wavelengths λ_{C1}, λ_{C2}, λ_{C3}, λ_{C4} in the C-band wavelength bandwidth and the lights in the wavelengths λ_{L1}, λ_{L2}, λ_{L3}, λ_{L4} in the L-band wavelength bandwidth are branched to the light of the single wavelength from the input WDM signal light and is then outputted, while the input lights are inserted to the WDM signal light as light in the wavelengths λ_{C5}, λ_{C6}, λ_{C7}, λ_{C8} and light in the wavelengths λ_{L5}, λ_{L6}, λ_{L7}, λ_{L8} and are then outputted after the multiplexing process.

The WDM signal light inputted to the input port of the OADM device is demultiplexed with the coupler 9A and is then inputted to the inputting (IN) port of the BRF1 6A and the optical amplifier 11A. The light amplified by the optical amplifier 11A is then demultiplexed by the coupler 9B and inputted to the wavelength selection modules 10A to 10D.

The wavelength selection module 10A among the wavelength selection modules 10A to 10D outputs the lights in the wavelengths λ_{C1}, and λ_{L1} to the dropping light port of the OADM device, while the wavelength selection modules 10B to 10D similarly output the lights in the wavelengths λ_{C2} to λ_{C4} and λ_{L2} to λ_{L4} to the dropping light port of the OADM device. Accordingly, the four wavelength selection modules 10A to 10D can select and output the eight wavelengths λ_{C1} to λ_{C4} and λ_{L1} to λ_{L4}.

Meanwhile, the light inputted to the adding port 1 of the OADM device is changed in the wavelength of the signal light with the transponder section 15A and is then outputted as the lights in the wavelengths λ_{C5} to λ_{C8}. The output lights in the wavelengths λ_{C5} to λ_{C8} are amplified by the optical amplifiers 11B to 11E, adjusted in the intensity by the ATTs 12A to 12D, multiplexed the coupler 9C and inputted to the adding (ADD) port of the BRF 16A.

Similarly, the light inputted to the adding port 2 of the OADM device is changed in the wavelength of the signal light by the transponder section 15B and outputted as the lights in the wavelengths λ_{L5} to λ_{L8}. The output wavelengths λ_{L5} to λ_{L8} are amplified by the optical amplifiers 11F to 11I, adjusted in the intensity by the ATT 12E to 12H, multiplexed by the coupler 9D and inputted to the adding (ADD) port of the BRF 16B.

To the inputting (IN) port of the BRF 16A, the WDM signal light demultiplexed by the coupler 9A is inputted and the lights in the wavelengths λ_{C5} to λ_{C8} are inputted by the coupler 9C to the adding (ADD) port of the BRF 16A. The RF signal frequencies corresponding to the wavelengths λ_{C5} to λ_{C8} are inputted to the BRF 16A in order to output the light inputted to the adding (ADD) port to the transmitting (THRU) port. Accordingly, the lights in the wavelengths λ_{C5} to λ_{C8} among the WDM signal light inputted to the inputting (IN) port are outputted to the dropping (DROP) port and thereby the lights except for the lights in the wavelengths XC₅ to λ_{C8} are outputted to the transmitting (THRU) port.

Similarly, the WDM signal light outputted from the transmitting (THRU) port of the BRF 16B is inputted to the inputting (IN) port of the BRF 16B and the lights in the wavelengths λ_{L5} to λ_{L8} are inputted by the coupler 9D to the adding (ADD) port of the BRF 16B. In order to output the light inputted to the adding (ADD) port to the adding (THRU) port, the RF signals in the frequencies corresponding to the wavelengths λ_{L5} to λ_{L8} are applied to the BRF 16B. Accordingly, the lights in the wavelengths λ_{L5} to λ_{L8}, among the WDM signal light inputted to the inputting (IN) port, are outputted to the dropping (DROP) port and thereby the lights except for the lights in the wavelengths λ_{L5} to λ_{L8} are outputted to the transmitting (THRU) port and then outputted to the output port of the OADM device.

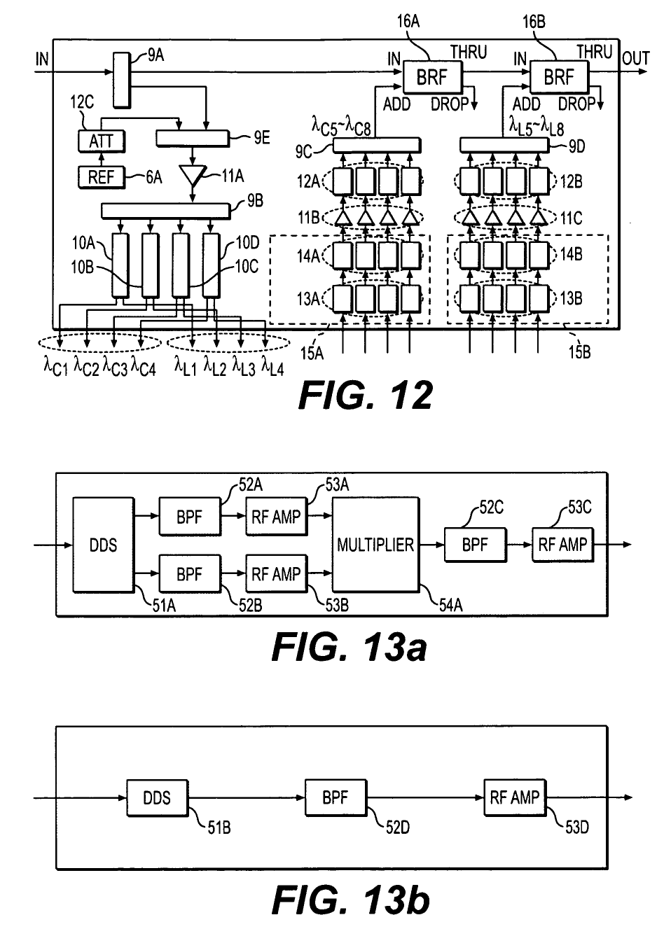

FIG. 12 illustrates a modification example of the embodiment of FIG. 11. In the OADM device illustrated in FIG. 12, the structural elements similar to those of FIG. 11 are designated with the similar reference numerals and the same description is not repeated here.

The light outputted from the reference light oscillating section 6A is inputted to the optical attenuator 12C for the adjustment to the desired optical power. The light adjusted to the predetermined optical power in the optical attenuator 12C is then inputted to the optical coupler 9E. In this coupler 9E, the WDM signal light demultiplexed by the optical coupler 9A is multiplexed to the light of the optical attenuator 12C and is then outputted therefrom. An output of the optical coupler 9E is inputted to the optical amplifier 11A and amplified up to the predetermined optical power. An output of the optical amplifier 11A is inputted to the optical coupler 9B. The optical coupler 9B demultiplexes the amplified input WDM signal light and the light from the reference light oscillating section to a plurality of lights and inputs these light signals to the wavelength selection modules 10A to 10D.

It is therefore no longer required, with the structure described above, to individually provide the reference light sources for the wavelength selection modules 10A to 10D and the structure can be simplified owing to the structure described above.

In FIG. 12, only one reference light oscillating section is provided by it is also possible to use a plurality of reference lights as illustrated in FIG. 8. In this case, a plurality of reference lights can be obtained by utilizing a plurality of reference light oscillating sections.

According to the seventh embodiment, as described above, the OADM device, which can increase the number of wavelengths to be added or dropped while the number of wavelength selecting sections to be used is reduced, can be constituted by introducing, into the OADM device, the variable wavelength selection module using only one wavelength selecting section which can select and output the two wavelengths not yet wavelength-multiplexed.

In the first, third and fifth embodiments, one wavelength in the C-band wavelength bandwidth and one wavelength in the L-band wavelength bandwidth are selected by only one wavelength selecting section and each wavelength is demultiplexed by the coupler. However, the selected wavelength of the wavelength selecting section can be demultiplexed with the coupler when this wavelength is in the other wavelength bandwidth. Therefore, the number of wavelengths to be selected and outputted is never limited to only tow wavelengths.

For example, three wavelengths not yet wavelength-multiplexed can be selected and outputted with the structure similar to that of the first to fifth embodiments by mixing the RF signal outputs from the three RF signal oscillating sections, selecting the lights in the C-band, L-band and S-band with the wavelength selecting section, and then demultiplexing each wavelength with the coupler.

The number of wavelength selecting sections to be used in the OADM device for adding and dropping the lights in the C-, L- and S-bands by utilizing the wavelength selection module which can select and output these lights of three wavelengths into the structure of the seventh embodiment.

What is claimed is:

1. A wavelength selection module comprising:
wavelength selecting means for inputting a light, multiplexing lights of a plurality of different wavelengths, and selecting and outputting lights of the plurality of wavelengths in accordance with a control signal applied from an external circuit; and
demultiplexing means for demultiplexing and outputting each wavelength of the output lights of said wavelength selecting means.

2. The wavelength selection module according to claim 1, further comprising means for inputting output lights of said demultiplexing means and outputting lights of unwanted wavelengths through an attenuation process.

3. The wavelength selection module according to claim 1, wherein the wavelength selection means is an acousto-optical tunable filter (AOTF).

4. The wavelength selection module according to claim 3, wherein the AOTF includes means for selecting a light of the wavelength corresponding to the frequency of an RF signal applied to an inter digit transducer through an RF signal input port.

5. A wavelength selection module comprising:
wavelength selecting means for selecting and outputting a plurality of wavelengths from an input light in accordance with an external control signal;
an optical filter including demultiplexing means for demultiplexing output light of said wavelength selecting means into lights of a plurality of wavelengths;
reference light source means for generating a reference light for said filter; and
multiplexing means for multiplexing input light and said reference light and inputting the multiplexed light to said wavelength selecting means.

6. The wavelength selection module according to claim 5, wherein said demultiplexing means includes monitor output and control signal for controlling said wavelength selecting section when the light of the wavelength of said reference light source is outputted to said monitor output and a control signal for controlling said wavelength selecting section based on the wavelength of said reference light source are controlled.

7. The wavelength selection module according to claim 6, wherein said reference light source generates lights of a plurality of wavelengths, a plurality of wavelengths demultiplexed by said demultiplexing means being respectively outputted to said monitor output, the control signal for controlling said wavelength selecting means when the light of the wavelength of said reference light source is outputted to said monitor output and the control signal for controlling said wavelength selecting means being based on the selected wavelength of said reference light source.

8. A wavelength selection module comprising:
wavelength selecting means for inputting lights of a plurality of different wavelengths;
branching means for branching output of said wavelength selecting section to a first light and a second light;
first filter means for inputting said second light and selectively transmitting light of the particular wavelength; and
control means for adjusting a relationship between a control signal applied to said wavelength selecting means and the selected wavelength on the basis of said control signal, output of said first filter and transmitting wavelength of said filter.

9. The wavelength selection module according to claim 8, wherein said control means includes means for controlling said control signal to continuously select the light selectively transmitted through one of said first and second filter with said wavelength selecting means.

10. The wavelength selection module according to claim 8, wherein said control means includes means for controlling an output of the light transmitted selectively with one of said first and second filters to said first light by controlling output of said control signal corresponding to the light selectively transmitted by said first or second filter.

11. The wavelength selection module according to claim 8, wherein said control means includes a third filter for inputting the first light and attenuating the wavelengths of lights selectively transmitted by said first or second filter.

12. A wavelength selection module comprising:
reference light source means for providing a constant output wavelength;
multiplexing means for multiplexing input light including lights of a plurality of different wavelengths and output light of said reference light source;
wavelength selecting means for inputting output light of said multiplexing means and selecting and outputting lights of a plurality of wavelengths in accordance with an external control signal;
branching means for branching output of said wavelength selecting means into a first light and a second light;
a first filter for inputting said second light and selectively transmitting light of the wavelength of output light from said reference light source; and
control means for adjusting a relationship between the control signal applied to said wavelength selecting means and the selected wavelength in accordance with said control signal, output of said first filter and wavelength of said reference light source.

13. The wavelength selection module according to claim 12, wherein said control means includes means for controlling said control signal to continuously select the light selectively transmitted through one of said first and second filter with said wavelength selecting means.

14. The wavelength selection module according to claim 12, wherein said control means includes means for controlling an output of the light transmitted selectively with one of said first and second filters to said first light by controlling output of said control signal corresponding to the light selectively transmitted by said first or second filter.

15. The wavelength selection module according to claim 12, wherein said control means includes a third filter for inputting the first light and attenuating the wavelengths of lights selectively transmitted by said first or second filters.

16. A wavelength selection module comprising:
first and second reference light source means for outputting a constant output wavelength;
multiplexing means for multiplexing input light including lights of a plurality of different wavelengths and output lights of said first and second reference light source means;
wavelength selecting section for inputting output light of said multiplexing means and selecting and outputting lights of a plurality of wavelengths in accordance with an external control signal;
branching means for branching output of said wavelength selecting means to the first to third lights;
first filter means for inputting said second light and selectively transmitting light of the output light wavelength of said first reference light source;
second filter means for inputting said third light and selectively outputting light of the output light wavelength of said second reference light source; and
control means for adjusting a relationship between the control signal applied to said wavelength selecting means and the selected wavelength based on the relationship among said control signal, output of said first filter and wavelength of said first reference light source and the relationship among said control signal, output of said second filter and wavelength of said second reference light source.

17. The wavelength selection module according to claim 16, wherein said control means includes means for controlling said control signal to continuously select the light selectively transmitted through one of said first and second filters with said wavelength selecting means

18. The wavelength selection module according to claim 16, wherein said control means includes means for controlling an output of the light transmitted selectively with one of said first and second filters to said first light by controlling output of said control signal corresponding to the light selectively transmitted by said first or second filter.

19. The wavelength selection module according to claim 16, wherein said control means includes a third filter for inputting the first light and attenuating the wavelengths of lights selectively transmitted by said first or second filter.

20. A method of effecting wavelength selection comprising:
inputting a light, multiplexing lights of a plurality of different wavelengths, and selecting and outputting lights of the plurality of wavelengths with a wavelength selecting means in accordance with a control signal applied from an external circuit; and
demultiplexing and outputting each wavelength of the output lights of said wavelength selecting means with demultiplexing means.
